(19) United States
(12) Patent Application Publication
(10) Pub. No.: US 2011/0033662 A1
(43) Pub. Date: Feb. 10, 2011

(54) LAMINATED FILM AND PRESSURE-SENSITIVE ADHESIVE TAPE

(75) Inventors: Shinsuke IKISHIMA, Ibaraki-shi (JP); Naoto Hayashi, Ibaraki-shi (JP); Kooki Ooyama, Ibaraki-shi (JP); Keiji Hayashi, Ibaraki-shi (JP); Shou Uchida, Ibaraki-shi (JP); Kouhei Takeda, Ibaraki-shi (JP); Ikkou Hanaki, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 12/836,347

(22) Filed: Jul. 14, 2010

(30) Foreign Application Priority Data
Jul. 23, 2009 (JP) 2009-172137
Jul. 23, 2009 (JP) 2009-172146
Apr. 6, 2010 (JP) 2010-087508
Apr. 6, 2010 (JP) 2010-087510

(51) Int. Cl. B32B 3/10

(52) U.S. Cl. 428/141

(57) ABSTRACT

Provided are a laminated film and a pressure-sensitive adhesive tape each of which is adjusted so as to be capable of achieving compatibility between low haze property excellent in transparency and such large surface roughness that foreign matter such as a fish eye is hardly observed without fluctuations in mechanical properties of the entire laminated film or pressure-sensitive adhesive tape. Also provided is such a pressure-sensitive adhesive tape as described below capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged, and further, the pressure-sensitive adhesive tape is adjusted so as to be capable of achieving compatibility between low haze property excellent in transparency and such large surface roughness that foreign matter such as a fish eye is hardly observed without fluctuations in mechanical properties of the entire pressure-sensitive adhesive tape. Also provided is such a pressure-sensitive adhesive tape as described below. When a prism sheet having multiple triangle pole-shaped prisms fixed on its surface is used as the above-mentioned member having unevenness on its surface, the pressure-sensitive adhesive tape functions as a surface protective film capable of effectively protecting a lens surface, and brings together sufficient pressure-sensitive adhesiveness for, and sufficient releasability from, the prism sheet. In addition, when the prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be suppressed. A laminated film of the present invention is a laminated film including a base material layer, a roughness-expressing layer, and a fine unevenness-erasing layer in the stated order, in which: the base material layer contains a thermoplastic resin; the roughness-expressing layer contains at least one kind of a resin component (A) selected from polyethylenes, ethylene-vinyl acetate copolymers, propylene-based polymers, and olefin-based thermoplastic elastomers; the fine unevenness-erasing layer contains a thermoplastic resin (B); an arithmetic average surface roughness Ra on the surface on the side of the fine unevenness-erasing layer is 1.0 μm to 3.0 μm; and the haze value of the laminated film is 30% or less.

### TECHNICAL FIELD

The present invention relates to a laminated film and a pressure-sensitive adhesive tape, and more specifically, to a laminated film and a pressure-sensitive adhesive tape in each of which a haze value and surface roughness are adjusted without fluctuations in mechanical properties of the entire laminated film or pressure-sensitive adhesive tape. In addition, the present invention relates to a pressure-sensitive adhesive tape capable of effectively protecting the uneven surface of a member having unevenness on its surface.

### BACKGROUND ART

In general, the haze value and surface roughness of each of films and pressure-sensitive adhesive tapes are adjusted in accordance with a purpose of the film or tape (such as the adjustment of an external appearance). A T-die extrusion touch roll molding method, i.e., a method involving bringing a molten resin extruded from a T-die into contact with a metal roll having an uneven pattern to transfer the uneven pattern onto the surface of the resin (film surface) has been known as a method of adjusting the haze value and the surface roughness (for example, Japanese Patent Application Laid-open No. 2003-181962 and Japanese Patent Application Laid-open No. 2004-149639).

However, when high-speed forming is to be performed, the T-die extrusion touch roll molding method may cause such a problem related to imperfect processing that the molten resin winds around the metal roll side owing to insufficient cooling of the resin or such a problem that the uneven pattern of the metal roll is not sufficiently transferred onto the resin.

Further, in the T-die extrusion touch roll molding method, a touch roll rubber surface is also generally subjected to uneven processing in order that the releasability of the molded products may be improved. Since the unevenness affects the haze value of the molded products, the following problem arises. That is, a molded product having a desired haze value (in particular, a middle to low haze value) is hardly obtained.

A method of adjusting a haze value and surface roughness except the T-die extrusion touch roll molding method is, for example, a T-die air-knife forming method or an inflation air-cooling forming method. However, those methods each involve forming unevenness on the surface of a molded product only by flow deformation during a time period commencing on the time of the melting of a resin and ending on the time of solidification by cooling. Accordingly, it is difficult to form the unevenness on the surface of a molded product precisely.

Attempts have been made to adjust a haze value even at the time of air-cooling forming by intentionally forming a sea-island phase-separated structure with two or more resins that are hardly compatible with each other as resins of which a film is formed or the surface region of the pressure-sensitive adhesive tapes is formed. However, in order that the haze value and surface roughness of the entire film or the entire surface region of the pressure-sensitive adhesive tapes may be adjusted by controlling its sea-island structure, the thickness of the film or surface region of the pressure-sensitive adhesive tapes must be secured in accordance with the adjustment. Accordingly, the thinning of the film or the pressure-sensitive adhesive tapes is hardly achieved. In addition, the composition of the materials to be used in the formation of the film or the surface region of the pressure-sensitive adhesive tapes must be adjusted on an as-needed basis depending on a desired haze value and desired surface roughness. As a result, the mechanical properties of the entire film or the entire pressure-sensitive adhesive tapes largely fluctuate in association with the adjustment of the haze value and the surface roughness. Accordingly, it is difficult to independently adjust the mechanical properties of the entire film or the entire pressure-sensitive adhesive tapes, and the haze value and surface roughness of the film or the pressure-sensitive adhesive tapes.

In addition, a pressure-sensitive adhesive tape to be used as a step material such as a protective film is requested to be a low-haze film because an external appearance inspection is performed while an object is protected with the film. However, in the case of the low-haze film, when foreign matter such as a fish eye in the film, foreign matter to be included at the time of attachment, or the like is present, the foreign matter or the like is visually observed as an external appearance defect. Accordingly, a possible approach to preventing the foreign matter or the like from being visually observed is an intentional increase in surface roughness of the film (that is, roughening).

In general, however, how high the haze of a film is and the magnitude of the surface roughness of the film are substantially proportional to each other. Accordingly, the increase of the surface roughness involves the emergence of the following problem. That is, the haze increases and transparency reduces, and hence an external appearance inspection can no longer be performed.

In addition, in general, pressure-sensitive adhesive tapes in each of which a pressure-sensitive adhesive layer is laminated on one surface of a film-shaped base material layer have been widely used for protecting the surfaces of assorted adherends.

Meanwhile, a large number of members each having unevenness formed on its surface exist for the purposes of imparting design, handling property, optical functionality, and the like. Any such member having unevenness formed on its surface involves the following problem. That is, dirt adheres to uneven portions or a convex portion is flawed. Any such pressure-sensitive adhesive tape as described above is used for preventing such problem.

Such pressure-sensitive adhesive tape needs to have such adhesion as not to be released during the protection of a member having unevenness formed on its surface. To that end, the pressure-sensitive adhesive tape must be provided with high adhesion by using a flexible pressure-sensitive adhesive in the pressure-sensitive adhesive layer. However, the use of the flexible pressure-sensitive adhesive in the pressure-sensitive adhesive layer involves the emergence of the following problem. That is, uneven apexes in the member having unevenness formed on its surface as an adherend penetrate the pressure-sensitive adhesive layer to reach the base material layer, and hence the uneven apexes are deformed.

On the other hand, when the adhesion between the member having unevenness formed on its surface and the pressure-sensitive adhesive tape is excessively strong, the following problem arises. That is, smooth release cannot be achieved upon release of the pressure-sensitive adhesive tape from the member having unevenness formed on its surface.

Therefore, the pressure-sensitive adhesive layer of the pressure-sensitive adhesive tape to be used for the protection of the member having unevenness formed on its surface must have such hardness that the uneven apexes do not reach the base material layer of the pressure-sensitive adhesive tape upon protection as well as mutually contradictory properties, i.e., pressure-sensitive adhesiveness and releasability.

A pressure-sensitive adhesive tape using a pressure-sensitive adhesive layer mainly formed of a styrene-based elastomer and having a thickness of 10 μm or less has been disclosed as a pressure-sensitive adhesive tape having a special pressure-sensitive adhesive layer (for example, Japanese Patent Application Laid-open No. 2007-332329).

However, the pressure-sensitive adhesive tape disclosed in Japanese Patent Application Laid-open No. 2007-332329 involves the emergence of the following problem. That is, when the tape is used for protecting the surface of a member having unevenness formed on its surface, uneven apexes penetrate the pressure-sensitive adhesive layer to reach the base material layer, and hence the uneven apexes are deformed. In addition, the pressure-sensitive adhesive tape disclosed in Japanese Patent Application Laid-open No. 2007-332329 involves the emergence of the following problem. That is, depending on the selection of a material for the tape, the tape does not have sufficient adhesion and is hence naturally released from the adherend, or the tape has so strong adhesion that the tape cannot be smoothly released from the adherend.

In addition, in general, surface protective films in each of which a pressure-sensitive adhesive layer is laminated on one surface of a film-shaped base material layer have been widely used for protecting the surfaces of assorted adherends.

On the other hand, prism sheets each having multiple triangle pole-shaped prisms fixed on the sheet surface have been used in assorted optical devices. In any such prism sheet, the following problem arises. That is, dirt adheres to a lens surface (prism surface) or a lens portion (prism portion) is flawed. Any such surface protective film as described above is used for preventing such problem.

A surface protective film for protecting the surface of a prism sheet needs to have such stable adhesion that the film is not released during the protection and can be smoothly released upon release when the protection is no longer needed. In addition, upon protection of the prism sheet with such surface protective film, a precisely formed prism pattern must not be subjected to any optical adverse effect.

Heretofore, a rubber-based pressure-sensitive adhesive has been generally used as a pressure-sensitive adhesive in a surface protective film for an optical member such as a prism sheet (for example, Japanese Patent Application Laid-open No. Hei 11-181370).

Meanwhile, a prism sheet to which a surface protective film is attached is transferred between steps in, for example, a laminated state or a continuously wound state. When the prism sheet is, for example, laminated as described above, lens portions (prism portions) of the prism sheet may deeply indent the surface protective film in an irregular fashion owing to the self weight of the prism sheet. When irregularity (indentation) emerges in the external appearance of the prism sheet to which the surface protective film is attached as described above, it becomes difficult to inspect the external appearance of the prism sheet in a state where the surface protective film is attached.

### SUMMARY OF INVENTION

### Technical Problem

The present invention has been made to solve the above-mentioned conventional problems, and an object of the present invention is to provide a laminated film and a pressure-sensitive adhesive tape each of which is adjusted so as to be capable of achieving compatibility between low haze property excellent in transparency and such large surface roughness that foreign matter such as a fish eye is hardly observed without fluctuations in mechanical properties of the entire laminated film or pressure-sensitive adhesive tape.

Another object of the present invention is to provide such a pressure-sensitive adhesive tape as described below capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged, and further, the pressure-sensitive adhesive tape is adjusted so as to be capable of achieving compatibility between low haze property excellent in transparency and such large surface roughness that foreign matter such as a fish eye is hardly observed without fluctuations in mechanical properties of the entire pressure-sensitive adhesive tape.

Another object of the present invention is to provide such a pressure-sensitive adhesive tape as described below. When a prism sheet having multiple triangle pole-shaped prisms fixed on its surface is used as the above-mentioned member having unevenness on its surface, the pressure-sensitive adhesive tape functions as a surface protective film capable of effectively protecting a lens surface, and brings together sufficient pressure-sensitive adhesiveness for, and sufficient releasability from, the prism sheet. In addition, when the prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be suppressed.

### Solution to Problem

A laminated film of the present invention is a laminated film including: a base material layer; a roughness-expressing layer; and a fine unevenness-erasing layer in the stated order, in which: the base material layer contains a thermoplastic resin; the roughness-expressing layer contains at least one kind of a resin component (A) selected from polyethylenes, ethylene-vinyl acetate copolymers, propylene-based polymers, and olefin-based thermoplastic elastomers; the fine unevenness-erasing layer contains a thermoplastic resin (B); an arithmetic average surface roughness Ra on the surface on the side of the fine unevenness-erasing layer is 1.0 μm to 3.0 μm; and the laminated film has a haze value of 30% or less.

In the preferred embodiment, the roughness-expressing layer has a thickness of 2 μm to 10 μm.

In the preferred embodiment, the fine unevenness-erasing layer has a thickness of 1 μm to 10 μm.

In the preferred embodiment, the roughness-expressing layer has two or more melting temperatures Tm in differential scanning calorimetry.

In the preferred embodiment, the roughness-expressing layer contains at least one kind selected from the propylene-based polymers and the olefin-based thermoplastic elastomers.

According to another aspect of the present invention, there is provided a pressure-sensitive adhesive tape. The pressure-sensitive adhesive tape includes a pressure-sensitive adhesive layer on one side of the laminated film.

In the preferred embodiment, a haze value of the pressure-sensitive adhesive tape is 30% or less.

In the preferred embodiment, the fine unevenness-erasing layer contains a long-chain alkyl-based releasing agent.

In the preferred embodiment, the pressure-sensitive adhesive layer has a first pressure-sensitive adhesive layer and a second pressure-sensitive adhesive layer in the stated order from the side of the laminated film, and a storage modulus of the first pressure-sensitive adhesive layer is higher than a storage modulus of the second pressure-sensitive adhesive layer.

In the more preferred embodiment, the first pressure-sensitive adhesive layer has a storage modulus of 1.0×10⁶ Pa or more and less than 1.0×10⁹ Pa at a frequency of 10 Hz and 23° C.

In the more preferred embodiment, the second pressure-sensitive adhesive layer has a storage modulus of 1.0×10³ Pa or more and less than 1.0×10⁶ Pa at a frequency of 10 Hz and 23° C.

In the more preferred embodiment, a pressure-sensitive adhesive of which the first pressure-sensitive adhesive layer is constituted is a thermoplastic pressure-sensitive adhesive, and a pressure-sensitive adhesive of which the second pressure-sensitive adhesive layer is constituted is a thermoplastic pressure-sensitive adhesive.

In the more preferred embodiment, the pressure-sensitive adhesive tape is a surface protective film for a prism sheet.

### ADVANTAGEOUS EFFECTS OF INVENTION

According to the present invention, there can be provided a laminated film and a pressure-sensitive adhesive tape each of which is adjusted so as to be capable of achieving compatibility between low haze property excellent in transparency and such large surface roughness that foreign matter such as a fish eye is hardly observed without fluctuations in mechanical properties of the entire laminated film or pressure-sensitive adhesive tape.

In addition, according to the present invention, there can be provided such a pressure-sensitive adhesive tape as described below capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged, and further, the pressure-sensitive adhesive tape is adjusted so as to be capable of achieving compatibility between low haze property excellent in transparency and such large surface roughness that foreign matter such as a fish eye is hardly observed without fluctuations in mechanical properties of the entire pressure-sensitive adhesive tape.

In addition, there can be provided such a pressure-sensitive adhesive tape as described below. When a prism sheet having multiple triangle pole-shaped prisms fixed on its surface is used as the above-mentioned member having unevenness on its surface, the pressure-sensitive adhesive tape functions as a surface protective film capable of effectively protecting a lens surface, and brings together sufficient pressure-sensitive adhesiveness for, and sufficient releasability from, the prism sheet. In addition, when the prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be suppressed.

### BRIEF DESCRIPTION OF DRAWINGS

FIG. 1 is a schematic sectional view of a laminated film according to a preferred embodiment of the present invention.

FIG. 2 is a schematic sectional view of a pressure-sensitive adhesive tape according to a preferred embodiment of the present invention.

FIG. 3 is a schematic sectional view of a pressure-sensitive adhesive tape according to another preferred embodiment of the present invention.

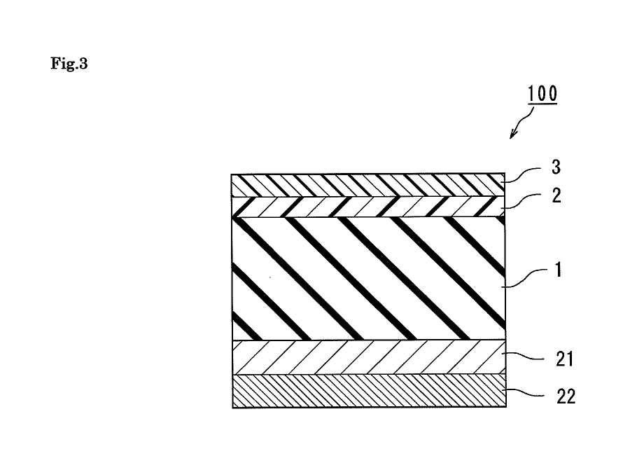

### DESCRIPTION OF EMBODIMENTS

### A. Laminated film

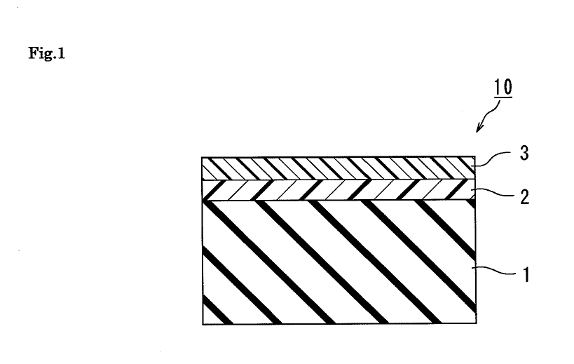

A laminated film of the present invention has a base material layer, a roughness-expressing layer, and a fine unevenness-erasing layer in the stated order. FIG. 1 is a schematic sectional view of a laminated film according to a preferred embodiment of the present invention. A laminated film 10 includes a base material layer 1, a roughness-expressing layer 2 placed on one side, or each of both sides, of the base material layer 1 (one side in the illustrated example), and a fine unevenness-erasing layer 3 placed on the side of the roughness-expressing layer 2 opposite to the base material layer 1. The laminated film of the present invention may further have any appropriate other layer (not illustrated) as required.

The thickness of the laminated film of the present invention can be set to any appropriate thickness depending on applications. The thickness is preferably 10 μm to 200 μm, more preferably 10 μm to 180 μm, or still more preferably 12 μm to 170 μm.

In the laminated film of the present invention, an arithmetic average surface roughness Ra on the surface on the side of the fine unevenness-erasing layer described above is preferably 1.0 μm to 3.0 μm, more preferably 1.0 μm to 2.9 μm, or still more preferably 1.1 μm to 2.8 μm. Such large surface roughness that foreign matter such as a fish eye is hardly observed can be achieved as long as the arithmetic average surface roughness Ra on the surface on the side of the fine unevenness-erasing layer described above falls within such range.

The laminated film of the present invention has a haze value of preferably 30% or less, more preferably 25% or less, still more preferably 22% or less, or particularly preferably 20% or less. A lower limit for the haze value of the laminated film of the present invention is ideally 0% because the lower the lower limit, the better in view of an object of the present invention. The laminated film can have low haze property excellent in transparency as long as the haze value of the laminated film falls within such range. The haze value can be measured by a method in conformity with JIS K7136.

### A-1. Base Material Layer

Any appropriate thickness can be adopted as the thickness of the above-mentioned base material layer, depending on applications. The thickness of the above-mentioned base material layer is preferably 10 μm to 150 μm, or more preferably 20 μm to 100 μm.

Any appropriate value can be adopted as the haze value of the above-mentioned base material layer as long as the haze value of the laminated film of the present invention is 30% or less.

The above-mentioned base material layer contains a thermoplastic resin. Any appropriate resin can be adopted as the above-mentioned thermoplastic resin as long as film forming by melt extrusion can be performed. Examples of the above-mentioned thermoplastic resin include: polyolefin resins such as a propylene-based polymer, a polyethylene, and an olefin-based thermoplastic elastomer (TPO) and modified products thereof; α-olefin-vinyl compound (such as vinyl acetate and (meth)acrylic acid ester) copolymers; polyamides; polyesters; polycarbonates; polyurethanes; and polyvinyl chlorides. Examples of the propylene-based polymer include a homopolypropylene, a block polypropylene, and a random polypropylene.

When a homopolypropylene is used as the above-mentioned thermoplastic resin, the structure of the homopolypropylene may be any one of an isotactic structure, an atactic structure, and a syndiotactic structure.

When a polyethylene is used as the above-mentioned thermoplastic resin, the polyethylene may be anyone of a low-density polyethylene, a medium-density polyethylene, and a high-density polyethylene.

In the above-mentioned base material layer, one kind of the above-mentioned thermoplastic resins may be used alone, or two or more kinds of them may be used in combination. When two or more kinds of the resins are used in combination, the resins may be blended, or may be copolymerized.

A commercially available product may be used as the above-mentioned thermoplastic resin. A specific example of the commercially available thermoplastic resin is a product available under the trade name “PF380A” (block polypropylene) from SunAllomer Ltd.

The above-mentioned base material layer can contain any appropriate additive as required. Examples of the additive that can be incorporated into the base material layer include a UV absorbing agent, a thermal stabilizer, a filler, and a lubricant. The kinds, number, and amount of the additive to be incorporated into the above-mentioned base material layer can be appropriately set depending on purposes.

Examples of the above-mentioned UV absorbing agent include a benzotriazole-based compound, a benzophenone-based compound, and a benzoate-based compound. Any appropriate content can be adopted as the content of the above-mentioned UV absorbing agent as long as the agent does not bleed out at the time of the forming of the laminated film. The content is representatively 0.01 part by weight to 5 parts by weight with respect to 100 parts by weight of the thermoplastic resin in the base material layer.

Examples of the above-mentioned thermal stabilizer include a hindered amine-based compound, a phosphorus-based compound, and a cyanoacrylate-based compound. Any appropriate content can be adopted as the content of the above-mentioned thermal stabilizer as long as the stabilizer does not bleed out at the time of the forming of the laminated film. The content is representatively 0.01 part by weight to 5 parts by weight with respect to 100 parts by weight of the thermoplastic resin in the base material layer.

Examples of the above-mentioned filler include inorganic fillers such as talc, titanium oxide, calcium carbonate, clay, mica, barium sulfate, whisker, and magnesium hydroxide. The filler has an average particle diameter of preferably 0.1 μm to 10 μm. The content of the filler is preferably 1 part by weight to 200 parts by weight with respect to 100 parts by weight of the thermoplastic resin in the base material layer.

### A-2. Roughness-Expressing Layer

The above-mentioned roughness-expressing layer has a thickness of preferably 2 μm to 10 μm, more preferably 2 μm to 8 μm, or particularly preferably 2 μm to 5 μm. When the thickness of the roughness-expressing layer is smaller than 2 μm, it may become difficult to obtain desired surface roughness. When the thickness of the roughness-expressing layer is larger than 10 μm, the mechanical properties of the roughness-expressing layer affect the mechanical properties of the entire laminated film, and hence the handling of the laminated film may deteriorate.

Any appropriate value can be adopted as the haze value of the above-mentioned roughness-expressing layer to such an extent that the haze value of the laminated film of the present invention is 30% or less.

The above-mentioned roughness-expressing layer contains at least one kind of a resin component (A) selected from polyethylenes, ethylene-vinyl acetate copolymers, propylene-based polymers, and olefin-based thermoplastic elastomers. The layer preferably contains at least one kind of the resin component (A) selected from the propylene-based polymers and the olefin-based thermoplastic elastomers.

Specific examples of the propylene-based polymers include a homopolypropylene, a block polypropylene, and a random polypropylene. A polypropylene obtained by using a metallocene catalyst may also be used as one of the propylene-based polymers.

Any appropriate olefin-based thermoplastic elastomer can be adopted as one of the olefin-based thermoplastic elastomers as long as the olefin-based thermoplastic elastomer is the so-called TPO.

The olefin-based thermoplastic elastomers each representatively have: a hard segment portion formed of a polyethylene or polypropylene; and a soft segment portion that is a rubber component (such as a hydrogenated (styrene) butadiene rubber or an ethylene-propylene rubber (e.g., an EPDM, an EPM, or an EBM)).

In one preferred embodiment, the above-mentioned roughness-expressing layer contains two or more kinds of resins showing different melt flow rates. When the roughness-expressing layer contains two or more kinds of resins showing different melt flow rates, the resin having the higher melt flow rate (low-viscosity resin) is easily elongated and the resin having the lower melt flow rate (high-viscosity resin) is hardly elongated upon forming by the elongation of each material of which the roughness-expressing layer is formed in a thermally molten state. Accordingly, a roughness-expressing layer having a sea-island structure in which the resin having the higher melt flow rate forms a sea portion and the resin having the lower melt flow rate forms an island portion can be obtained. As a result, the roughness-expressing layer can be caused to express its surface roughness by unevenness resulting from the sea-island structure. The melt flow rate can be measured by a method in conformity with JIS K7210.

The above-mentioned resin having the higher melt flow rate (low-viscosity resin) has a melt flow rate of preferably 5 g/10 min to 100 g/10 min, more preferably 5 g/10 min to 80 g/10 min, or particularly preferably 5 g/10 min to 50 g/10 min. When the melt flow rate of the above-mentioned resin having the higher melt flow rate is lower than 5 g/10 min, a difference in melt flow rate between the resin having the lower melt flow rate and the above-mentioned resin having the higher melt flow rate reduces, and hence the surface roughness of the roughness-expressing layer may become excessively small. When the melt flow rate is higher than 100 g/10 min, the surface roughness of the roughness-expressing layer may become excessively large.

The above-mentioned resin having the lower melt flow rate (high-viscosity resin) has a melt flow rate of preferably 0.1 g/10 min to 4.9 g/10 min, more preferably 0.2 g/10 min to 4.5 g/10 min, or particularly preferably 0.2 g/10 min to 3 g/10 min. When the melt flow rate of the above-mentioned resin having the lower melt flow rate is lower than 0.1 g/10 min, the surface roughness of the roughness-expressing layer may become excessively large. When the melt flow rate is higher than 4.9 g/10 min, the difference in melt flow rate between the resin having the higher melt flow rate and the above-mentioned resin having the lower melt flow rate reduces, and hence the surface roughness of the roughness-expressing layer may become excessively small.

As long as the melt flow rates of the above-mentioned resin having the higher melt flow rate (low-viscosity resin) and the above-mentioned resin having the lower melt flow rate (high-viscosity resin) fall within such ranges as described above, a roughness-expressing layer having a sea-island structure in which the resin having the higher melt flow rate forms a sea portion and the resin having the lower melt flow rate forms an island portion can be obtained.

The surface roughness of the roughness-expressing layer can be controlled by adjusting the difference between the melt flow rate of the above-mentioned resin having the higher melt flow rate (low-viscosity resin) and the melt flow rate of the above-mentioned resin having the lower melt flow rate (high-viscosity resin). That is, when the difference in melt flow rates is large, the materials of which the roughness-expressing layer is formed largely differ from each other in ease of elongation, and hence a roughness-expressing layer having a clear sea-island structure can be obtained. Accordingly, a roughness-expressing layer having large surface roughness can be obtained. On the other hand, when the difference in melt flow rates is small, the materials of which the roughness-expressing layer is formed slightly differ from each other in ease of elongation, and hence a roughness-expressing layer having a clear sea-island structure is hardly obtained. Accordingly, a roughness-expressing layer having small surface roughness is obtained.

The above-mentioned roughness-expressing layer preferably has two or more melting temperatures Tm in differential scanning calorimetry (DSC). Such roughness-expressing layer can be obtained by using two or more kinds of resins having different melting points. The surface roughness of the roughness-expressing layer can be adjusted by using the two or more kinds of resins having different melting points in the roughness-expressing layer by virtue of the difference in melting point. To be additionally specific, when the difference in melting point is large, a clear sea-island structure can be obtained in the above-mentioned roughness-expressing layer because, upon solidification by cooling after thermal melting at the time of the forming of the film, the resin having the higher melting point previously solidifies before the resin having the lower melting point solidifies. As a result, a roughness-expressing layer having large surface roughness can be obtained. On the other hand, when the difference in melting point is small, a roughness-expressing layer having a clear sea-island structure is hardly obtained, and hence a roughness-expressing layer having small surface roughness is obtained. It should be noted that the above-mentioned melting temperatures Tm can be measured by a method in conformity with JIS K7121. The phrase “has two or more melting temperatures Tm” as used herein refers to a state where two or more melting endothermic peaks appear in a DSC curve.

When the above-mentioned roughness-expressing layer is formed by using two kinds of resins having different melting points, the difference in melting point is preferably 5° C. to 65° C., more preferably 10° C. to 60° C., or particularly preferably 15° C. to 50° C. As long as the difference in melting point falls within such range, a clear sea-island structure can be obtained in the above-mentioned roughness-expressing layer. As a result, a roughness-expressing layer having large surface roughness can be obtained.

The surface roughness of the above-mentioned roughness-expressing layer can be adjusted by compatibility between the two or more kinds of resins in the above-mentioned roughness-expressing layer as well. When the compatibility is low, a clear sea-island structure can be obtained in the above-mentioned roughness-expressing layer, and hence a roughness-expressing layer having large surface roughness can be obtained. On the other hand, when the compatibility is high, a clear sea-island structure is hardly obtained, and hence a roughness-expressing layer having small surface roughness is obtained.

Upon formation of the above-mentioned roughness-expressing layer, an approach involving the use of a single resin as well as an approach involving the use of two or more kinds of resins as described above is available. Such single resin is, for example, a block polymer having a low-viscosity portion (soft segment) and a high-viscosity portion (hard segment). To be specific, the block polymer is an olefin-based thermoplastic elastomer formed of a block copolymer.

In view of the foregoing, the resin component (A) used for forming the above-mentioned roughness-expressing layer (resin component (A) in the above-mentioned roughness-expressing layer) is preferably, for example, (1) a combination of a low-viscosity resin and a high-viscosity resin, (2) a combination of a high-melting point resin and a low-melting point resin, (3) a combination of resins each of which is lowly compatible with the other, or (4) a block polymer having a low-viscosity portion (soft segment) and a high-viscosity portion (hard segment). Specific examples of the resin component include: a combination of a propylene-based polymer and an olefin-based thermoplastic elastomer; and an olefin-based thermoplastic elastomer having a low-viscosity portion (soft segment) and a high-viscosity portion (hard segment).

Commercially available products may be used as the propylene-based polymer and the olefin-based thermoplastic elastomer described above.

Specific examples of the commercially available propylene-based polymer include products available under the trade names “WINTEC WFX4” and “WINTEC WFX6” from Japan Polypropylene Corporation. A specific example of the commercially available olefin-based thermoplastic elastomer is a product available under the trade name “Catalloy Q300F” from SunAllomer Ltd.

The above-mentioned roughness-expressing layer can contain any appropriate additive as required. For example, any one of the additives described in the section A-1 can be used as the additive that can be incorporated into the roughness-expressing layer.

### A-3. Fine Unevenness-Erasing Layer

The above-mentioned fine unevenness-erasing layer has a thickness of preferably 1 μm to 10 μm, more preferably 1 μm to 7 μm, still more preferably 1 μm to 5 μm, or particularly preferably 2 μm to 5 μm. When the thickness of the fine unevenness-erasing layer is smaller than 1 μm, fine unevenness cannot be sufficiently erased, and hence the haze of the entire laminated film of the present invention may increase. When the thickness of the fine unevenness-erasing layer is larger than 10 μm, even large unevenness may be filled, and hence the surface roughness of the laminated film of the present invention may be smooth.

Any appropriate value can be adopted as the haze value of the above-mentioned fine unevenness-erasing layer to such an extent that the haze value of the laminated film of the present invention is 30% or less.

The above-mentioned fine unevenness-erasing layer contains a thermoplastic resin (B).

Any appropriate thermoplastic resin can be adopted as the thermoplastic resin (B). For example, any one of the thermoplastic resins described in the section A-1 can be used. The thermoplastic resin (B) is preferably a polyethylene.

In the laminated film of the present invention, roughness formed by the roughness-expressing layer is formed of fine unevenness and large unevenness. However, the fine unevenness must be filled with the above-mentioned fine unevenness-erasing layer, and the large unevenness must not be filled with the layer. Accordingly, the melt flow rate of the thermoplastic resin (B) in the above-mentioned fine unevenness-erasing layer is preferably larger than the melt flow rate of each resin component (A) in the roughness-expressing layer described above.

The melt flow rate of the above-mentioned fine unevenness-erasing layer is preferably 6 g/10 min to 100 g/10 min, more preferably 7 g/10 min to 80 g/10 min, or particularly preferably 8 g/10 min to 50 g/10 min.

### A-4. Other Layer

The laminated film of the present invention may further have any appropriate other layer as required (not illustrated).

The above-mentioned other layer has a thickness of preferably 2 μm to 12 μm, or more preferably 5 μm to 10 μm.

Any appropriate value can be adopted as the haze value of the above-mentioned other layer as long as the haze value of the laminated film of the present invention is 30% or less.

The above-mentioned other layer is, for example, a smooth layer. For example, when the above-mentioned laminated film has the roughness-expressing layer and the fine unevenness-erasing layer on one side of the base material layer, the smooth layer can be used by being placed on the side of the base material layer where the roughness-expressing layer and the fine unevenness-erasing layer are not placed.

Any appropriate material can be adopted as a material of which the above-mentioned smooth layer is constituted. A polyolefin resin such as a polyethylene, a polypropylene, or a TPO can be adopted as the material of which the smooth layer is constituted. Specific examples of the polyolefin resin include various thermoplastic resins such as: various polyethylenes having low- to high-densities; and various polypropylenes including isotactic, atactic, and syndiotactic polypropylenes. In addition, a modified product of an α-olefin, a copolymer of an α-olefin and any one of various vinyl compounds such as vinyl acetate and a methacrylate, or such a thermoplastic resin as to be mainly formed of, for example, a polyamide, polyester, polycarbonate, polyurethane, or polyvinyl chloride as well as the polyolefin resin may be adopted. One kind of those materials may be used alone, or two or more kinds of them may be used in combination.

### A-5. Method of Forming Laminated Film

The above-mentioned laminated film can be obtained by any appropriate forming method. A representative example of the method involves subjecting the above-mentioned base material layer, the above-mentioned roughness-expressing layer, and the above-mentioned fine unevenness-erasing layer, and as required, the other layer to co-extrusion. The co-extrusion method can be performed with an extruder and a co-extrusion die for the respective materials of which the respective layers are formed in conformity with, for example, an inflation method or a T-die method. Any other production method is, for example, a method involving attaching the base material layer, the roughness-expressing layer, and the fine unevenness-erasing layer, and as required, the other layer each formed by a calender forming method with any appropriate adhesive.

### B. Pressure-Sensitive Adhesive Tape

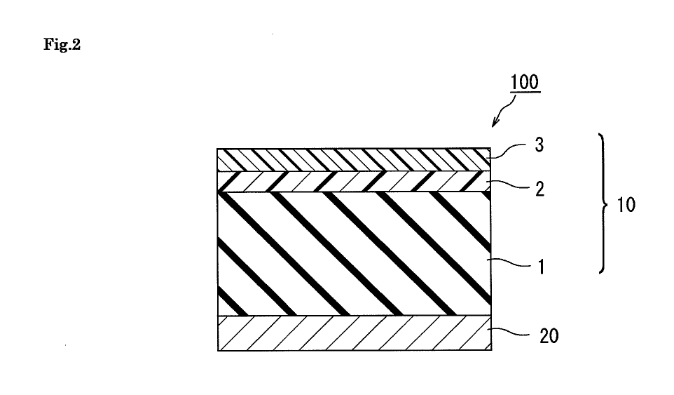

A pressure-sensitive adhesive tape of the present invention has the laminated film of the present invention and a pressure-sensitive adhesive layer placed on one side of the laminated film. FIG. 2 is a schematic sectional view of a pressure-sensitive adhesive tape according to a preferred embodiment of the present invention. A pressure-sensitive adhesive tape 100 includes the laminated film 10 and a pressure-sensitive adhesive layer 20 placed on the side of the laminated film 10 where the roughness-expressing layer 2 and the fine unevenness-erasing layer 3 are not placed. The laminated film 10 of which the pressure-sensitive adhesive tape of the present invention is constituted is the laminated film of the present invention described above, and includes the base material layer 1 described in the section A-1, the roughness-expressing layer 2 described in the section A-2, and the fine unevenness-erasing layer 3 described in the section A-3.

The fine unevenness-erasing layer used in the pressure-sensitive adhesive tape of the present invention may contain a releasing agent such as a silicone-based releasing agent, a fluorine-based releasing agent, a long-chain alkyl-based releasing agent, or an aliphatic amide-based releasing agent as required. When the fine unevenness-erasing layer contains the releasing agent, attachment between the fine unevenness-erasing layer and the pressure-sensitive adhesive layer in a state where portions of the pressure-sensitive adhesive tape overlap each other such as storage in a roll shape can be prevented. In addition, there is no need to cover the fine unevenness-erasing layer with a separator layer, and hence a pressure-sensitive adhesive tape having a desired haze value and desired surface roughness can be easily obtained. Of the above-mentioned releasing agents, the long-chain alkyl-based releasing agent is particularly preferred. In addition, a method of subjecting the fine unevenness-erasing layer to a releasing treatment is not limited to an approach involving adding any one of various releasing materials such as the above-mentioned releasing agents. Any appropriate approach involving subjecting the fine unevenness-erasing layer to a friction treatment or involving irradiating the fine unevenness-erasing layer with electron beams to cause the layer to express releasability may be employed to such an extent that an effect of the present invention is not impaired.

The above-mentioned long-chain alkyl-based releasing agent contains a long-chain alkyl-based polymer. The long-chain alkyl-based polymer can be obtained by causing a polymer having a reactive group and a compound having an alkyl group capable of reacting with the reactive group to react with each other in any appropriate heated solvent. A catalyst may be used as required at the time of the reaction. Examples of the catalyst include a tin compound and a tertiary amine.

Examples of the above-mentioned reactive group include a hydroxyl group, an amino group, a carboxyl group, and a maleic anhydride group. Examples of a polymer having the reactive group include an ethylene-vinyl alcohol copolymer, polyvinyl alcohol, polyethylenimine, polyethylenamine, a styrene-maleic anhydride copolymer. Of those, an ethylene-vinyl alcohol copolymer is preferred. It should be noted that the term “ethylene-vinyl alcohol copolymer” also includes a partially saponified product of ethylene-vinyl acetate copolymer. The term “polyvinyl alcohol” also includes a partially saponified product of polyvinyl acetate.

The number of carbon atoms of the above-mentioned alkyl group is preferably 8 to 30, or more preferably 12 to 22. When the number of carbon atoms of the above-mentioned alkyl group falls within such range, a roughness-expressing layer having excellent releasability can be obtained. Specific examples of such alkyl group include a lauryl group, a stearyl group, and a behenyl group. Examples of a compound having such alkyl group (that is, compound having an alkyl group capable of reacting with the above-mentioned reactive group) include: isocyanates such as octyl isocyanate, decyl isocyanate, lauryl isocyanate, and stearyl isocyanate; acid chlorides; amines; and alcohols. Of those, isocyanates are preferred.

The above-mentioned long-chain alkyl-based polymer has a weight-average molecular weight of preferably 10,000 to 1,000,000, or more preferably 20,000 to 1,000,000. When the weight-average molecular weight of the long-chain alkyl-based polymer falls within such range, a roughness-expressing layer having excellent releasability can be obtained.

The above-mentioned long-chain alkyl-based releasing agent is kneaded into the fine unevenness-erasing layer upon co-extrusion of the laminated film or the pressure-sensitive adhesive tape. The content of the long-chain alkyl-based releasing agent in the above-mentioned fine unevenness-erasing layer is preferably 1% by weight to 50% by weight, more preferably 2% by weight to 30% by weight, or particularly preferably 5% by weight to 20% by weight. When the content is smaller than 1% by weight, an effect of adding the long-chain alkyl-based releasing agent may not be obtained. When the content is larger than 50% by weight, a bled product may be generated.

The thickness of the pressure-sensitive adhesive tape of the present invention can be set to any appropriate thickness depending on applications. The thickness is representatively 15 μm to 450 μm.

The pressure-sensitive adhesive tape of the present invention has a haze value of preferably 30% or less, more preferably 25% or less, still more preferably 22% or less, or particularly preferably 20% or less. A lower limit for the haze value of the pressure-sensitive adhesive tape of the present invention is ideally 0% because the lower the lower limit, the better in view of an object of the present invention. The pressure-sensitive adhesive tape can have low haze property excellent in transparency as long as the haze value of the pressure-sensitive adhesive tape falls within such range. The haze value can be measured by a method in conformity with JIS K7136.

### B-1. Pressure-Sensitive Adhesive Layer

The above-mentioned pressure-sensitive adhesive layer has a thickness of preferably 1 μm to 300 μm, more preferably 4 μm to 100 μm, or particularly preferably 5 μm to 50 μm.

Any appropriate value can be adopted as the haze value of the above-mentioned pressure-sensitive adhesive layer as long as the haze value of the pressure-sensitive adhesive tape of the present invention is 30% or less.

Any appropriate pressure-sensitive adhesive can be adopted as a pressure-sensitive adhesive of which the above-mentioned pressure-sensitive adhesive layer is constituted. Examples of the above-mentioned pressure-sensitive adhesive include a rubber-based pressure-sensitive adhesive, an acrylic pressure-sensitive adhesive, and a silicone-based pressure-sensitive adhesive.

A thermoplastic pressure-sensitive adhesive can also be used as the above-mentioned pressure-sensitive adhesive. A material of which the thermoplastic pressure-sensitive adhesive is constituted is, for example, any appropriate styrene-based block copolymer or acrylic thermoplastic resin as a pressure-sensitive adhesive material.

Specific examples of the above-mentioned styrene-based block copolymer include: styrene-based AB-type diblock copolymers such as a styrene-ethylene-butylene copolymer (SEB); styrene-based ABA-type triblock copolymers such as a styrene-butadiene-styrene copolymer (SBS), a hydrogenated product of SBS (styrene-ethylene-butylene-styrene copolymer (SEBS)), a styrene-isoprene-styrene copolymer (SIS), a hydrogenated product of SIS (styrene-ethylene-propylene-styrene copolymer (SEPS)), and a styrene-isobutylene-styrene copolymer (SIBS); styrene-based ABAB-type tetrablock copolymers such as styrene-butadiene-styrene-butadiene (SBSB); styrene-based ABABA-type pentablock copolymers such as styrene-butadiene-styrene-butadiene-styrene (SBSBS); styrene-based multi-block copolymers having six or more of A-B repeat units; and hydrogenated product each obtained by hydrogenating ethylenic double bonds of a styrene-based random copolymer such as a styrene-butadiene rubber (SBR). Examples of a commercially available product include a “G1657” (styrene-based elastomer) manufactured by Kraton Polymers. One kind of the above-mentioned polymers may be used alone, or two or more kinds of them may be used in combination.

The content of a styrene block structure in the above-mentioned styrene-based block copolymer is preferably 5% by weight to 40% by weight, more preferably 7% by weight to 30% by weight, or particularly preferably 9% by weight to 20% by weight. When the content of the styrene block structure is smaller than 5% by weight, an adhesive residue is apt to be generated owing to an insufficient cohesive strength of the pressure-sensitive adhesive layer. When the content of the styrene block structure is larger than 40% by weight, the pressure-sensitive adhesive layer becomes hard, and good adhesion for a rough surface may not be obtained.

When the above-mentioned styrene-based block copolymer has an ethylene-butylene block structure, the content of a constituent unit derived from butylene in the ethylene-butylene block structure is preferably 50% by weight or more, more preferably 60% by weight or more, particularly preferably 70% by weight or more, or most preferably 70% by weight to 90% by weight. When the content of the constituent unit derived from butylene falls within such range, a pressure-sensitive adhesive layer excellent in wettability and adhesion, and capable of favorably adhering even to a rough surface can be obtained.

Examples of the above-mentioned acrylic thermoplastic resin include: a polymethyl methacrylate-polybutyl acrylate-polymethyl methacrylate copolymer (PMMA-PBA-PMMA copolymer); and a PMMA-functional group-containing PBA-PMMA copolymer of such a type that the polybutyl acrylate has a carboxylic acid as a functional group. A commercially available product may be used as the acrylic thermoplastic resin. Specific examples of the commercially available acrylic thermoplastic resin include a product available under the trade name “NABSTAR” from KANEKA CORPORATION and a product available under the trade name “LA Polymer” from KURARAY CO., LTD.

The above-mentioned pressure-sensitive adhesive layer can contain any other component as required. Examples of the other component include: an olefin-based resin; a silicone-based resin; a liquid acrylic copolymer; a polyethyleneimine; a fatty acid amide; a phosphate ester; and a general additive. The kinds, number, and amount of other components to be incorporated into the above-mentioned pressure-sensitive adhesive layer can be appropriately set depending on purposes. Examples of the above-mentioned additive include: a tackifier; a softening agent; an antioxidant; a hindered amine-based light stabilizer; a UV absorbing agent; and a filler or pigment such as calcium oxide, magnesium oxide, silica, zinc oxide, or titanium oxide.

The compounding of the tackifier is effective in improving an adhesion. The compounding amount of the tackifier is suitably determined to be any appropriate compounding amount depending on an adherend in order that the emergence of an adhesive residue problem due to a reduction in cohesive strength may be avoided. In ordinary cases, the amount is preferably 0 to 40 parts by weight, more preferably 0 to 30 parts by weight, or still more preferably 0 to 10 parts by weight with respect to 100 parts by weight of the resin material of which the pressure-sensitive adhesive is formed.

Examples of the tackifier include: petroleum-based resins such as an aliphatic copolymer, an aromatic copolymer, an aliphatic/aromatic copolymer system, and an alicyclic copolymer; rosin-based resins such as a coumarone-indene-based resin, a terpene-based resin, a terpene phenol-based resin, and polymerized rosin; (alkyl)phenol-based resins; xylene-based resins; and hydrogenated products of the resins. One kind of the tackifiers may be used alone, or two or more kinds of them may be used in combination.

A hydrogenated tackifier such as an “ARCON P-125” manufactured by Arakawa Chemical Industries, Ltd. is preferred as the tackifier in terms of, for example, releasability and weatherability. It should be noted that a product commercially available as a blend with an olefin resin or thermoplastic elastomer can also be used as the tackifier.

The compounding of the softening agent is effective in improving the adhesion. Examples of the softening agent include a low-molecular-weight diene-based polymer, a polyisobutylene, a hydrogenated polyisoprene, a hydrogenated polybutadiene, and derivatives of them. Examples of the derivatives include those each having an OH group or COOH group on one of, or each of both of, its terminals. Specific examples of such derivatives include a hydrogenated polybutadiene diol, a hydrogenated polybutadiene monool, a hydrogenated polyisoprene diol, and a hydrogenated polyisoprene monool. A hydrogenated product of a diene-based polymer such as a hydrogenated polybutadiene or a hydrogenated polyisoprene, an olefin-based softening agent, or the like is preferred in order that a rise in adhesion for the adherend may be additionally suppressed. To be specific, a “Kuraprene LIR-200” manufactured by KURARAY CO., LTD. is exemplified. One kind of those softening agents may be used alone, or two or more kinds of them may be used in combination.

The molecular weight of the softening agent can be suitably set to any appropriate weight. When the molecular weight of the softening agent is excessively small, the small molecular weight may cause, for example, the transfer of a substance from the pressure-sensitive adhesive layer to the adherend or heavy release. On the other hand, when the molecular weight of the softening agent is excessively large, an improving effect on the adhesion tends to be poor. Accordingly, the number-average molecular weight of the softening agent is preferably 5000 to 100,000, or more preferably 10,000 to 50,000.

When the softening agent is used, any appropriate amount can be adopted as its addition amount. When the addition amount of the softening agent is excessively large, the amount of an adhesive residue at high temperatures or at the time of exposure to outdoors tends to increase. Accordingly, the addition amount is preferably 40 parts by weight or less, more preferably 20 parts by weight or less, or still more preferably 10 parts by weight or less with respect to 100 parts by weight of the resin material of which the pressure-sensitive adhesive is formed. When the addition amount of the softening agent exceeds 40 parts by weight with respect to 100 parts by weight of the resin material of which the pressure-sensitive adhesive is formed, the adhesive residue under a high-temperature environment or under exposure to outdoors becomes remarkable.

One, or each of both, of the surfaces of the above-mentioned pressure-sensitive adhesive layer may be subjected to a surface treatment as required. Examples of the surface treatment include a corona discharge treatment, a UV irradiation treatment, a flame treatment, a plasma treatment, and a sputter etching treatment.

The above-mentioned pressure-sensitive adhesive layer may have a first pressure-sensitive adhesive layer and a second pressure-sensitive adhesive layer in the stated order from the side of the above-mentioned laminated film.

The above-mentioned first pressure-sensitive adhesive layer and the above-mentioned second pressure-sensitive adhesive layer each have a thickness of preferably 1 μm to 300 μm, more preferably 1 μm to 100 μm, or particularly preferably 1 μm to 50 μm.

Any appropriate value can be adopted as the haze value of each of the above-mentioned first pressure-sensitive adhesive layer and the above-mentioned second pressure-sensitive adhesive layer.

Any appropriate pressure-sensitive adhesive can be adopted as a pressure-sensitive adhesive of which each of the above-mentioned first pressure-sensitive adhesive layer and the above-mentioned second pressure-sensitive adhesive layer is constituted. Examples of the above-mentioned pressure-sensitive adhesive include a rubber-based pressure-sensitive adhesive, an acrylic pressure-sensitive adhesive, and a silicone-based pressure-sensitive adhesive.

A thermoplastic pressure-sensitive adhesive can also be used as the above-mentioned pressure-sensitive adhesive. With regard to a material of which the thermoplastic pressure-sensitive adhesive is constituted, a pressure-sensitive adhesive material is, for example, any appropriate styrene-based block copolymer or acrylic thermoplastic resin.

Specific description of the above-mentioned styrene-based block copolymer is the same as the foregoing. Specific description of the above-mentioned acrylic thermoplastic resin is also the same as the foregoing.

The above-mentioned first pressure-sensitive adhesive layer and the above-mentioned second pressure-sensitive adhesive layer can each contain any other component as required. Examples of the other component include: an olefin-based resin; a silicone-based resin; a liquid acrylic copolymer; a polyethyleneimine; a fatty acid amide; a phosphate; and a general additive. The kinds, number, and amount of the above-mentioned other components can be appropriately set depending on purposes. Examples of the above-mentioned additive include: a tackifier; a softening agent; an antioxidant; a hindered amine-based light stabilizer; a UV absorbing agent; a thermal stabilizer; and a filler or pigment such as calcium oxide, magnesium oxide, silica, zinc oxide, or titanium oxide.

The compounding of the tackifier is effective in improving adhesion. The compounding amount of the tackifier is suitably determined to be any appropriate compounding amount depending on an adherend in order that the emergence of an adhesive residue problem due to a reduction in cohesive strength may be avoided. In ordinary cases, the amount is preferably 0 to 40 parts by weight, more preferably 0 to 30 parts by weight, or still more preferably 0 to 10 parts by weight with respect to 100 parts by weight of the pressure-sensitive adhesive in the above-mentioned first pressure-sensitive adhesive layer or the above-mentioned second pressure-sensitive adhesive layer.

Specific description of the tackifier is the same as the foregoing.

The compounding of the softening agent is effective in improving the adhesion. Specific description of the softening agent is the same as the foregoing.

When the softening agent is used, any appropriate amount can be adopted as its addition amount. When the addition amount of the softening agent is excessively large, the amount of an adhesive residue at high temperatures or at the time of exposure to outdoors tends to increase. Accordingly, the addition amount is preferably 40 parts by weight or less, more preferably 20 parts by weight or less, or still more preferably 10 parts by weight or less with respect to 100 parts by weight of the pressure-sensitive adhesive in the above-mentioned first pressure-sensitive adhesive layer or the above-mentioned second pressure-sensitive adhesive layer. When the addition amount of the softening agent exceeds 40 parts by weight with respect to 100 parts by weight of the pressure-sensitive adhesive in the above-mentioned first pressure-sensitive adhesive layer or the above-mentioned second pressure-sensitive adhesive layer, the adhesive residue under a high-temperature environment or under exposure to outdoors becomes remarkable.

Examples of the above-mentioned UV absorbing agent include a benzotriazole-based compound, a benzophenone-based compound, and a benzoate-based compound. Any appropriate content can be adopted as the content of the above-mentioned UV absorbing agent as long as the agent does not bleed out at the time of the forming. The content is representatively 0.01 part by weight to 5 parts by weight with respect to 100 parts by weight of the pressure-sensitive adhesive.

Examples of the above-mentioned thermal stabilizer include a hindered amine-based compound, a phosphorus-based compound, and a cyanoacrylate-based compound. Any appropriate content can be adopted as the content of the above-mentioned thermal stabilizer as long as the stabilizer does not bleed out at the time of the forming. The content is representatively 0.01 part by weight to 5 parts by weight with respect to 100 parts by weight of the pressure-sensitive adhesive in the first pressure-sensitive adhesive layer or the above-mentioned second pressure-sensitive adhesive layer.

One, or each of both, of the surfaces of the above-mentioned first pressure-sensitive adhesive layer and the above-mentioned second pressure-sensitive adhesive layer may be each subjected to a surface treatment as required. Examples of the surface treatment include a corona discharge treatment, a UV irradiation treatment, a flame treatment, a plasma treatment, and a sputter etching treatment.

The above-mentioned first pressure-sensitive adhesive layer has a storage modulus (G′) of preferably 1.0×10⁶ Pa or more and less than 1.0×10⁹ Pa, more preferably 1.0×10⁶ Pa or more and less than 1.0×10⁸ Pa, or still more preferably 1.0×10⁶ Pa or more and less than 1.0×10⁷ Pa at a frequency of 10 Hz and 23° C. As long as the storage modulus of the above-mentioned first pressure-sensitive adhesive layer falls within the above-mentioned range, when a member having unevenness on its surface is protected with the pressure-sensitive adhesive tape of the present invention having the first pressure-sensitive adhesive layer and the resultant is deformed by, for example, lamination or continuous winding, the deformation of the uneven shape and damage to the base material layer in the pressure-sensitive adhesive tape can be effectively prevented. In addition, as long as the storage modulus of the above-mentioned first pressure-sensitive adhesive layer falls within the above-mentioned range, when a prism sheet is protected with the pressure-sensitive adhesive tape of the present invention and the resultant is brought into a state such as a laminated state or a continuously wound state, the emergence of irregularity (indentation) in the external appearance of the prism sheet to which the pressure-sensitive adhesive tape is attached can be effectively suppressed.

The above-mentioned second pressure-sensitive adhesive layer has a storage modulus (G′) of preferably 1.0×10³ Pa or more and less than 1.0×10⁶ Pa, more preferably 5.0×10³ Pa or more and less than 1.0×10⁶ Pa, or still more preferably 1.0×10⁴ Pa or more and less than 1.0×10⁶ Pa at a frequency of 10 Hz and 23° C. As long as the storage modulus of the above-mentioned second pressure-sensitive adhesive layer falls within the above-mentioned range, the pressure-sensitive adhesive tape of the present invention having the second pressure-sensitive adhesive layer can bring together sufficient pressure-sensitive adhesiveness for, and sufficient releasability from, a member having unevenness on its surface. In addition, as long as the storage modulus of the above-mentioned second pressure-sensitive adhesive layer falls within the above-mentioned range, the pressure-sensitive adhesive of the present invention can bring together sufficient pressure-sensitive adhesiveness for, and sufficient releasability from, a prism sheet.

It should be noted that the term “storage modulus (G′)” as used in the present invention refers to a value measured with a dynamic viscoelasticity spectrum-measuring device (ARES manufactured by Rheometric Scientific) at a frequency of 10 Hz and a rate of temperature increase of 5° C./min in the range of −50° C. to 100° C. In addition, in the case of a laminate in which two or more pressure-sensitive adhesive layers are laminated like the pressure-sensitive adhesive tape of the present invention, it is sufficient that: the laminate be obliquely cut with, for example, a surface and interfacial cutting analysis system (SAICAS); and multiple sites of the cut surface be subjected to measurement with a microhardness-measuring apparatus such as a nanoindenter.

In the pressure-sensitive adhesive tape of the present invention, the storage modulus of the above-mentioned first pressure-sensitive adhesive layer is preferably higher than the storage modulus of the above-mentioned second pressure-sensitive adhesive layer. As long as the storage modulus of the above-mentioned first pressure-sensitive adhesive layer is higher than the storage modulus of the above-mentioned second pressure-sensitive adhesive layer, the pressure-sensitive adhesive tape of the present invention can bring together sufficient pressure-sensitive adhesiveness for, and sufficient releasability from, a member having unevenness on its surface. Further, even upon deformation of the member protected with the pressure-sensitive adhesive tape by, for example, lamination or continuous winding, the uneven shape hardly deforms and the base material layer in the pressure-sensitive adhesive tape is hardly damaged. In addition, as long as the storage modulus of the above-mentioned first pressure-sensitive adhesive layer is higher than the storage modulus of the above-mentioned second pressure-sensitive adhesive layer, the pressure-sensitive adhesive tape of the present invention can bring together sufficient pressure-sensitive adhesiveness for, and sufficient releasability from, a prism sheet. Further, when a prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be effectively suppressed. In the pressure-sensitive adhesive tape of the present invention, a difference between the storage modulus of the above-mentioned first pressure-sensitive adhesive layer at a frequency of 10 Hz and 23° C., and the storage modulus of the above-mentioned second pressure-sensitive adhesive layer at a frequency of 10 Hz and 23° C. is preferably 3×10⁵ Pa or more. The above-mentioned difference in storage modulus is more preferably 4×10⁵ Pa to 1×10⁷ Pa, or still more preferably 5×10⁵ Pa to 5×10⁶ Pa. As long as the difference between the storage modulus of the above-mentioned first pressure-sensitive adhesive layer at a frequency of 10 Hz and 23° C., and the storage modulus of the above-mentioned second pressure-sensitive adhesive layer at a frequency of 10 Hz and 23° C. is 3×10⁵ Pa or more, the pressure-sensitive adhesive tape of the present invention can bring together sufficient pressure-sensitive adhesiveness for, and sufficient releasability from, a member having unevenness on its surface. Further, even upon deformation of the member protected with the pressure-sensitive adhesive tape by, for example, lamination or continuous winding, the uneven shape hardly deforms and the base material layer in the pressure-sensitive adhesive tape is hardly damaged.

### B-2. Method of Producing Pressure-Sensitive Adhesive Tape

The pressure-sensitive adhesive tape of the present invention can be obtained by any appropriate production method. The pressure-sensitive adhesive tape of the present invention can be obtained by, for example, a method involving subjecting the above-mentioned fine unevenness-erasing layer, the above-mentioned roughness-expressing layer, and the above-mentioned base material layer of which the laminated film of the present invention is constituted, and the above-mentioned pressure-sensitive adhesive layer to co-extrusion (production method 1-1), a method involving subjecting the above-mentioned fine unevenness-erasing layer, the above-mentioned roughness-expressing layer, and the above-mentioned base material layer of which the laminated film of the present invention is constituted, and the above-mentioned first pressure-sensitive adhesive layer and the above-mentioned second pressure-sensitive adhesive layer to co-extrusion (production method 1-2), a method involving performing the hot-melt application of the pressure-sensitive adhesive of which the above-mentioned pressure-sensitive adhesive layer is constituted onto the above-mentioned base material layer of the laminated film of the present invention (production method 2-1), a method involving performing the hot-melt application of the pressure-sensitive adhesive of which the above-mentioned first pressure-sensitive adhesive layer is constituted and the pressure-sensitive adhesive of which the above-mentioned second pressure-sensitive adhesive layer is constituted in the stated order onto the above-mentioned base material layer of the laminated film of the present invention (production method 2-2), a method involving applying an organic solvent application liquid in which the pressure-sensitive adhesive of which the above-mentioned pressure-sensitive adhesive layer is constituted is dissolved or an emulsion liquid in which the pressure-sensitive adhesive of which the above-mentioned pressure-sensitive adhesive layer is constituted is water-dispersed onto the above-mentioned base material layer of the laminated film of the present invention (production method 3-1), or a method involving applying an organic solvent application liquid in which the pressure-sensitive adhesive of which the above-mentioned first pressure-sensitive adhesive layer is constituted is dissolved or an emulsion liquid in which the pressure-sensitive adhesive of which the above-mentioned first pressure-sensitive adhesive layer is constituted is water-dispersed onto the above-mentioned base material layer of the laminated film of the present invention and applying an organic solvent application liquid in which the pressure-sensitive adhesive of which the above-mentioned second pressure-sensitive adhesive layer is constituted is dissolved or an emulsion liquid in which the pressure-sensitive adhesive of which the above-mentioned second pressure-sensitive adhesive layer is constituted is water-dispersed onto the applied liquid (production method 3-2). It should be noted that the laminated film in each of the production methods 2-1, 2-2, 3-1, and 3-2 can be obtained by the method described in the section A-3.

When the pressure-sensitive adhesive tape is produced by the above-mentioned production method 1-1, 1-2, 2-1 or 2-2, the above-mentioned thermoplastic pressure-sensitive adhesive is preferably used as the pressure-sensitive adhesive of which the pressure-sensitive adhesive layer is constituted.

A method for the above-mentioned co-extrusion in the above-mentioned production method 1-1 can be performed with an extruder and a co-extrusion die for the respective materials of which the fine unevenness-erasing layer, the roughness-expressing layer, the base material layer, and the pressure-sensitive adhesive layer are formed in conformity with, for example, an inflation method or a T-die method.

A method for the above-mentioned co-extrusion in the above-mentioned production method 1-2 can be performed with an extruder and a co-extrusion die for the respective materials of which the fine unevenness-erasing layer, the roughness-expressing layer, the base material layer, the first pressure-sensitive adhesive layer, and the second pressure-sensitive adhesive layer are formed in conformity with, for example, an inflation method or a T-die method.

When the pressure-sensitive adhesive tape is produced by the above-mentioned production method 2-1, 2-2, 3-1, or 3-2, the surface onto which the pressure-sensitive adhesive is applied, that is, the above-mentioned base material layer of the above-mentioned laminated film is preferably subjected to an easy-adhesion treatment. Examples of the easy-adhesion treatment include a corona discharge treatment, an ITRO treatment (silicification flame treatment), and an anchor coat treatment.

When the pressure-sensitive adhesive tape is produced by the above-mentioned production method 3-1 or 3-2, the above-mentioned rubber-based pressure-sensitive adhesive, acrylic pressure-sensitive adhesive, or silicone-based pressure-sensitive adhesive is preferably used as the above-mentioned pressure-sensitive adhesive.

When the pressure-sensitive adhesive tape is produced by the above-mentioned production method 3-1 or 3-2, any appropriate solvent can be adopted as the above-mentioned organic solvent. Examples of the above-mentioned organic solvent include: aromatic hydrocarbon-based solvents such as toluene and xylene; aliphatic carboxylic acid ester-based solvents such as ethyl acetate; and aliphatic hydrocarbon-based solvents such as hexane, heptane, and octane. One kind of the above-mentioned organic solvents may be used alone, or two or more kinds of them may be used in combination.

When the pressure-sensitive adhesive tape is produced by the above-mentioned production method 3-1 or 3-2, a cross-linking agent may be incorporated into the organic solvent application liquid. Examples of the cross-linking agent include an epoxy-based cross-linking agent, an isocyanate-based cross-linking agent, and an aziridine cross-linking agent.

Any appropriate application method can be adopted as an application method in the case where the pressure-sensitive adhesive tape is produced by the above-mentioned production method 3-1 or 3-2. Examples of the application method include methods each involving the use of a bar coater, a gravure coater, a spin coater, a roll coater, a knife coater, or an applicator.

### EXAMPLES

Hereinafter, the present invention is specifically described by way of examples. However, the present invention is by no means limited by these examples. It should be noted that, in the examples and the like, test and evaluation methods are as described below, and the term “part(s)” means “part(s) by weight.”

### (1) Arithmetic Average Surface Roughness Ra

After a laminated film or a pressure-sensitive adhesive tape had been attached to a slide glass, the surface roughness of its surface layer was measured with an optical profiler NT9100 (manufactured by Veeco) under the conditions “Measurement Type: VSI (Infinite Scan), Objective: 2.5×, FOV: 1.0×, Modulation Threshold: 0.1%” for n=3. After the measurement, data analysis was performed under the conditions “Terms Removal: Tilt Only (Plane Fit), Window Filtering: None.” Thus, the arithmetic average surface roughness Ra was determined.

### (2) Haze Value

Measurement was performed with a HAZEMETER HM-150 (manufactured by Murakami Color Research Laboratory Co., Ltd.). The haze was calculated in conformity with JIS K7136 from the equation “haze (%)=Td/Tt×100 (Td: diffuse transmittance, Tt: total light transmittance).”

### (3) Storage Modulus (G′)

A material of which each pressure-sensitive adhesive layer was formed was kneaded with a biaxial kneader, and was then formed into a film shape (200 μm). The storage modulus of the formed sample was measured with a dynamic viscoelasticity spectrum-measuring device (ARES manufactured by Rheometric Scientific) at a frequency of 10 Hz and a rate of temperature increase of 5° C./min in the range of −50° C. to 100° C.

### (4) Evaluation for Adhesion

The adhesion of a pressure-sensitive adhesive tape was measured in conformity with JIS 20237 (2000). A test sample obtained by cutting the pressure-sensitive adhesive tape so as to have a predetermined width (20 mm) was attached to a prism sheet, and then the resultant was subjected to crimping with a rubber roller at a load of 2 kg once. After that, the resultant was left to stand at a load of 11 g/cm² under a 50° C. atmosphere for 24 hours. The sample was peeled in a 180° direction at a tension speed of 300 mm/min, and a resistance at the time was defined as the adhesion of the test sample. The whole peeling operation was performed under an atmosphere having a temperature of 23° C. and a humidity of 65% RH (relative humidity).

### (5) Evaluation for Prism Sheet Lens Apex Angle Portion Indentation Depth

A test sample obtained by cutting a pressure-sensitive adhesive tape into a size measuring 20 cm by 5 cm was attached to a prism sheet cut into a size measuring 20 cm by 5 cm, and then the resultant was subjected to crimping with a rubber roller at a load of 2 kg once. After that, the resultant was left to stand at a load of 11 g/cm² under a 50° C. atmosphere for 24 hours. After that, the test sample was peeled from the prism sheet, and then the surface of the test sample attached to the prism sheet was evaluated for prism sheet lens apex angle portion indentation depth with an optical profiler NT9100 (manufactured by Veeco). The measurement was performed under the following conditions “Measurement Type: VSI, Objective Lens: ×2.5, Internal Lens: ×0.5, Backscan: 10 μm, Length: 15 μm, threshold: 1%, Window Filtering: None, 5 mm×5 mm, n=10.” The average of the data was calculated.

### (6) Evaluation for Deformation of Prism Sheet Apex Angle

The uneven surface of the prism sheet from which the test sample had been peeled in the above-mentioned section (5) was visually observed and evaluated for whether or not an apex angle deformed. The evaluation can be performed because, when the apex angle deformed, only the deformed portion shows a color different from that of any other portion owing to the refraction of light.

∘: No deformation was observed.

x: Deformation was observed.

### (7) Observation of Indentation

A lens surface of the prism sheet from which the test sample had been peeled in the above-mentioned section (5) was visually observed, and then observation as to whether or not an indentation emerged was performed.

∘: No indentation was observed.

x: An indentation was observed.

### Example 1

The following compounds were prepared as a roughness-expressing layer-forming material, a fine unevenness-erasing layer-forming material, a base material layer-forming material, and a smooth layer-forming material.

Roughness-expressing layer-forming material: A mixture of 75 parts of a reactor TPO (Catalloy Q300F manufactured by SunAllomer Ltd.; melt flow rate (MFR)=0.8 (230° C., 2.16 kgf)) and 25 parts of a polypropylene obtained by using a metallocene catalyst (WINTEC WFX4 manufactured by Japan Polypropylene Corporation; melt flow rate (MFR)=7.0 (230° C., 2.16 kgf))

Fine unevenness-erasing layer-forming material: A low-density polyethylene (NOVATEC LD LC720 manufactured by Japan Polyethylene Corporation; melt flow rate (MFR)=9.4 (190° C., 2.16 kgf))

Base material layer-forming material: A block polypropylene (PF380a manufactured by SunAllomer Ltd.)

Smooth layer-forming material: A low-density polyethylene (NOVATEC LD LC720 manufactured by Japan Polyethylene Corporation; melt flow rate (MFR)=9.4 (190° c., 2.16 kgf)).

The above-mentioned materials were molded by T-die melt co-extrusion. Thus, a laminated film (1) including the fine unevenness-erasing layer, the roughness-expressing layer, the base material layer, and the smooth layer in the stated order was obtained. The fine unevenness-erasing layer had a thickness of 2 μm, the roughness-expressing layer had a thickness of 2 μm, the base material layer had a thickness of 38 μm, and the smooth layer had a thickness of 7 μm. Table 1 shows the results of the evaluation of the resultant laminated film (1).

### Example 2

A laminated film (2) was obtained in the same manner as in Example 1 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, and the smooth layer had a thickness of 7 μm. Table 1 shows the results of the evaluation of the resultant laminated film (2).

### Example 3

A laminated film (3) was obtained in the same manner as in Example 1 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, and the smooth layer had a thickness of 7 μm. Table 1 shows the results of the evaluation of the resultant laminated film (3).

### Example 4

A laminated film (4) was obtained in the same manner as in Example 1 except that 100 parts of a reactor TPO (Catalloy Q300F manufactured by SunAllomer Ltd.; melt flow rate (MFR)=0.8 (230° C., 2.16 kgf)) were used as the roughness-expressing layer-forming material. The fine unevenness-erasing layer had a thickness of 2 μm, the roughness-expressing layer had a thickness of 2 μm, the base material layer had a thickness of 38 μm, and the smooth layer had a thickness of 7 μm. Table 1 shows the results of the evaluation of the resultant laminated film (4).

### Example 5

A laminated film (5) was obtained in the same manner as in Example 4 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, and the smooth layer had a thickness of 7 μm. Table 1 shows the results of the evaluation of the resultant laminated film (5).

### Example 6

A laminated film (6) was obtained in the same manner as in Example 4 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, and the smooth layer had a thickness of 7 μm. Table 1 shows the results of the evaluation of the resultant laminated film (6).

### Example 7

The following compounds were prepared as a roughness-expressing layer-forming material, a fine unevenness-erasing layer-forming material, a base material layer-forming material, and a pressure-sensitive adhesive layer-forming material.

Roughness-expressing layer-forming material: A mixture of 75 parts of a reactor TPO (Catalloy Q300F manufactured by SunAllomer Ltd.; melt flow rate (MFR)=0.8 (230° C., 2.16 kgf)) and 75 parts of a polypropylene obtained by using a metallocene catalyst (WINTEC WFX4 manufactured by Japan Polypropylene Corporation; melt flow rate (MFR)=7.0 (230° C., 2.16 kgf))

Fine unevenness-erasing layer-forming material: A mixture of 91 parts of a low-density polyethylene (NOVATEC LD LC720 manufactured by Japan Polyethylene Corporation; melt flow rate (MFR)=9.4 (190° C., 2.16 kgf)) and 9 parts of a long-chain alkyl-based releasing agent (Ashioresin RA95HS (completely saponified polyvinyl octadecyl carbamate-based releasing agent) manufactured by Ashio Co., Ltd.)

Base material layer-forming material: A block polypropylene (PF380a manufactured by SunAllomer Ltd.)

Pressure-sensitive adhesive layer-forming material: A mixture of 75 parts of a styrene-ethylene-butylene-styrene block copolymer (SEBS) (G1657 manufactured by Kraton Polymers) and 25 parts of a tackifier (ARCON P-125 manufactured by Arakawa Chemical Industries, Ltd.)

The above-mentioned materials were molded by T-die melt co-extrusion. Thus, a pressure-sensitive adhesive tape (1) including the fine unevenness-erasing layer, the roughness-expressing layer, the base material layer, and the pressure-sensitive adhesive layer in the stated order was obtained. The fine unevenness-erasing layer had a thickness of 2 μm, the roughness-expressing layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (1).

### Example 8

A pressure-sensitive adhesive tape (2) was obtained in the same manner as in Example 7 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, and the pressure-sensitive adhesive layer had a thickness of 7 μm. Table 2 shows the results of the evaluation of the resultant pressure-sensitive adhesive tape (2).

### Example 9

A pressure-sensitive adhesive tape (3) was obtained in the same manner as in Example 7 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, and the pressure-sensitive adhesive layer had a thickness of 7 μm. Table 2 shows the results of the evaluation of the resultant pressure-sensitive adhesive tape (3).

### Example 10

A pressure-sensitive adhesive tape (4) was obtained in the same manner as in Example 7 except that 100 parts of a reactor TPO (Catalloy Q300F manufactured by SunAllomer Ltd.; melt flow rate (MFR)=0.8 (230° C., 2.16 kgf)) were used as the roughness-expressing layer-forming material. The fine unevenness-erasing layer had a thickness of 2 μm, the roughness-expressing layer had a thickness of 2 μm, the base material layer had a thickness of 38 μm, and the pressure-sensitive adhesive layer had a thickness of 7 μm. Table shows the results of the evaluation of the resultant pressure-sensitive adhesive tape (4).

### Example 11

A pressure-sensitive adhesive tape (5) was obtained in the same manner as in Example 8 except that 100 parts of a reactor TPO (Catalloy Q300F manufactured by SunAllomer Ltd.; melt flow rate (MFR)=0.8 (230° C., 2.16 kgf)) were used as the roughness-expressing layer-forming material. The fine unevenness-erasing layer had a thickness of 2 μm, the roughness-expressing layer had a thickness of 5 μm, the base material layer had a thickness of 38 μm, and the pressure-sensitive adhesive layer had a thickness of 7 μm. Table 2 shows the results of the evaluation of the resultant pressure-sensitive adhesive tape (5).

### Example 12

A pressure-sensitive adhesive tape (6) was obtained in the same manner as in Example 9 except that 100 parts of a reactor TPO (Catalloy Q300F manufactured by SunAllomer Ltd.; melt flow rate (MFR)=0.8 (230° C., 2.16 kgf)) were used as the roughness-expressing layer-forming material. The fine unevenness-erasing layer had a thickness of 2 μm, the roughness-expressing layer had a thickness of 10 μm, the base material layer had a thickness of 38 μm, and the pressure-sensitive adhesive layer had a thickness of 7 μm. Table shows the results of the evaluation of the resultant pressure-sensitive adhesive tape (6).

### Comparative Example 1

A laminated film (C1) was obtained in the same manner as in Example 1 except that a mixture of 30 parts of an ethylene-vinyl acetate copolymer (EVAFLEX EV270 manufactured by DUPONT-MITSUI POLYCHEMICALS CO., LTD.; melt flow rate (MFR)=1.0 (190° C., 2.16 kgf)) and 70 parts of a low-density polyethylene (Petrocene 209 manufactured by TOSOH CORPORATION; melt flow rate (MFR)=45 (190° C., 2.16 kgf)) was used as the roughness-expressing layer-forming material. The fine unevenness-erasing layer had a thickness of 2 μm, the roughness-expressing layer had a thickness of 2 μm, the base material layer had a thickness of 38 μm, and the smooth layer had a thickness of 7 μm. Table 1 shows the results of the evaluation of the resultant laminated film (C1).

### Comparative Example 2

A laminated film (C2) was obtained in the same manner as in Comparative Example 1 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, and the smooth layer had a thickness of 7 μm. Table 1 shows the results of the evaluation of the resultant laminated film (C2).

### Comparative Example 3

A laminated film (C3) was obtained in the same manner as in Comparative Example 1 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, and the smooth layer had a thickness of 7 μm. Table 1 shows the results of the evaluation of the resultant laminated film (C3).

### Comparative Example 4

A laminated film (C4) was obtained in the same manner as in Comparative Example 1 except that the thickness of the fine unevenness-erasing layer was changed to 0 μm (in other words, the layer was not laminated). The fine unevenness-erasing layer had a thickness of 0 μm (in other words, the layer was not laminated), the roughness-expressing layer had a thickness of 2 μm, the base material layer had a thickness of 38 μm, and the smooth layer had a thickness of 7 μm. Table 1 shows the results of the evaluation of the resultant laminated film (C4).

### Comparative Example 5

A laminated film (C5) was obtained in the same manner as in Comparative Example 1 except that the thickness of the fine unevenness-erasing layer was changed to 1 μm. The fine unevenness-erasing layer had a thickness of 1 μm, the roughness-expressing layer had a thickness of 2 μm, the base material layer had a thickness of 38 μm, and the smooth layer had a thickness of 7 μm. Table 1 shows the results of the evaluation of the resultant laminated film (C5).

### Comparative Example 6

A laminated film (C6) was obtained in the same manner as in Comparative Example 1 except that 100 parts of an ethylene-vinyl acetate copolymer (EVAFLEX EV270 manufactured by DUPONT-MITSUI POLYCHEMICALS CO., LTD.; melt flow rate (MFR)=1.0 (190° C., 2.16 kgf)) were used as the roughness-expressing layer-forming material. The fine unevenness-erasing layer had a thickness of 2 μm, the roughness-expressing layer had a thickness of 2 μm, the base material layer had a thickness of 38 μm, and the smooth layer had a thickness of 7 μm. Table 1 shows the results of the evaluation of the resultant laminated film (C6).

### Comparative Example 7

A laminated film (C7) was obtained in the same manner as in Comparative Example 6 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, and the smooth layer had a thickness of 7 μm. Table 1 shows the results of the evaluation of the resultant laminated film (C7).

### Comparative Example 8

A laminated film (C8) was obtained in the same manner as in Comparative Example 6 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, and the smooth layer had a thickness of 7 μm. Table 1 shows the results of the evaluation of the resultant laminated film (C8).

### Comparative Example 9

A laminated film (C9) was obtained in the same manner as in Comparative Example 1 except that 100 parts of a random polypropylene (NOVATEC PP EG8 manufactured by Japan Polypropylene Corporation; melt flow rate (MFR)=0.8 (230° C., 2.16 kgf)) were used as the roughness-expressing layer-forming material. The fine unevenness-erasing layer had a thickness of 2 μm, the roughness-expressing layer had a thickness of 2 μm, the base material layer had a thickness of 38 μm, and the smooth layer had a thickness of 7 μm. Table 1 shows the results of the evaluation of the resultant laminated film (C9).

### Comparative Example 10

A laminated film (C10) was obtained in the same manner as in Comparative Example 9 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, and the smooth layer had a thickness of 7 μm. Table 1 shows the results of the evaluation of the resultant laminated film (C10).

### Comparative Example 11

A laminated film (C11) was obtained in the same manner as in Example 1 except that the thickness of the fine unevenness-erasing layer was changed to 0 μm (in other words, the layer was not laminated). The fine unevenness-erasing layer had a thickness of 0 μm (in other words, the layer was not laminated), the roughness-expressing layer had a thickness of 2 μm, the base material layer had a thickness of 38 μm, and the smooth layer had a thickness of 7 μm. Table 1 shows the results of the evaluation of the resultant laminated film (C11).

### Comparative Example 12

A laminated film (C12) was obtained in the same manner as in Example 4 except that the thickness of the fine unevenness-erasing layer was changed to 0 μm (in other words, the layer was not laminated). The fine unevenness-erasing layer had a thickness of 0 μm (in other words, the layer was not laminated), the roughness-expressing layer had a thickness of 2 μm, the base material layer had a thickness of 38 μm, and the smooth layer had a thickness of 7 μm. Table 1 shows the results of the evaluation of the resultant laminated film (C12).

### Comparative Example 13

The following compounds were prepared as a roughness-expressing layer-forming material, a fine unevenness-erasing layer-forming material, a base material layer-forming material, and a pressure-sensitive adhesive layer-forming material.

Roughness-expressing layer-forming material: A mixture of 30 parts of an ethylene-vinyl acetate copolymer (EVAFLEX EV270 manufactured by DUPONT-MITSUI POLYCHEMICALS CO., LTD.; melt flow rate (MFR)=1.0 (190° C., 2.16 kgf)) and 70 parts of a low-density polyethylene (Petrocene 209 manufactured by TOSOH CORPORATION; melt flow rate (MFR)=45 (190° C., 2.16 kgf))

Fine unevenness-erasing layer-forming material: A mixture of 91 parts of a low-density polyethylene (NOVATEC LD LC720 manufactured by Japan Polyethylene Corporation; melt flow rate (MFR)=9.4 (190° C., 2.16 kgf)) and 9 parts of a long-chain alkyl-based releasing agent (Ashioresin RA95HS (completely saponified polyvinyl octadecyl carbamate-based releasing agent) manufactured by Ashio Co., Ltd.)

Base material layer-forming material: A block polypropylene (PF380A manufactured by SunAllomer Ltd.)

Pressure-sensitive adhesive layer-forming material: A mixture of 75 parts of a styrene-ethylene-butylene-styrene block copolymer (SEBS) (G1657 manufactured by Kraton Polymers) and 25 parts of a tackifier (ARCON P-125 manufactured by Arakawa Chemical Industries, Ltd.)

The above-mentioned materials were molded by T-die melt co-extrusion. Thus, a pressure-sensitive adhesive tape (C1) including the fine unevenness-erasing layer, the roughness-expressing layer, the base material layer, and the pressure-sensitive adhesive layer in the stated order was obtained. The fine unevenness-erasing layer had a thickness of 2 μm, the roughness-expressing layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C1).

### Comparative Example 14

A pressure-sensitive adhesive tape (C2) was obtained in the same manner as in Comparative Example 13 except that the thickness of the fine unevenness-erasing layer was changed to 1 μm. The fine unevenness-erasing layer had a thickness of 1 μm, the roughness-expressing layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C2).

### Comparative Example 15

A pressure-sensitive adhesive tape (C3) was obtained in the same manner as in Example 7 except that the thickness of the fine unevenness-erasing layer was changed to 0 μm (in other words, the layer was not laminated). The fine unevenness-erasing layer had a thickness of 0 μm (in other words, the layer was not laminated), the roughness-expressing layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C3).

### Comparative Example 16

A pressure-sensitive adhesive tape (C4) was obtained in the same manner as in Example 10 except that the thickness of the fine unevenness-erasing layer was changed to 0 μm (in other words, the layer was not laminated). The fine unevenness-erasing layer had a thickness of 0 μm (in other words, the layer was not laminated), the roughness-expressing layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C4).

TABLE 1

| | | | Example 1 | Example 2 | Example 3 | Example 4 | Example 5 | Example 6 |
|---|---|---|---|---|---|---|---|---|
| Fine | Trade name of main material | | NOVATEC LD | NOVATEC LD | NOVATEC LD | NOVATEC LD | NOVATEC LD | NOVATEC LD |
| unevenness- | | | LC720 | LC720 | LC720 | LC720 | LC720 | LC720 |
| erasing layer | MFR (g/10 min) | | 9.4 | 9.4 | 9.4 | 9.4 | 9.4 | 9.4 |
| | Thickness (μm) | | 2 | 2 | 2 | 2 | 2 | 2 |
| Roughness- | Material (1) | Trade name | Catalloy | Catalloy | Catalloy | Catalloy | Catalloy | Catalloy |
| expressing | | | Q300F | Q300F | Q300F | Q300F | Q300F | Q300F |
| layer | | MFR (g/10 min) | 0.8 | 0.8 | 0.8 | 0.8 | 0.8 | 0.8 |
| | Material (2) | Trade name | WINTEC | WINTEC | WINTEC | — | — | — |
| | | | WFX4 | WFX4 | WFX4 | | | |
| | | MFR (g/10 min) | 7.0 | 7.0 | 7.0 | — | — | — |

| | Material (1):Material (2) | 75:25 | 75:25 | 75:25 | 100:0 | 100:0 | 100:0 |
|---|---|---|---|---|---|---|---|
| | Thickness (μm) | 2 | 5 | 10 | 2 | 5 | 10 |
| Base | Trade name of material | PF380A | | | | | |
| material | | | | | | | |
| layer | | | | | | | |
| Smooth layer | Trade name of material | NOVATEC LD LC720 | | | | | |
| | Haze value (%) | 16.1 | 16.2 | 21.7 | 9.0 | 11.4 | 15.4 |
| | Arithmetic average surface | 2.65 | 1.13 | 1.12 | 2.11 | 2.36 | 1.21 |
| | roughness Ra (μm) | | | | | | |

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Fine | Trade name of main material | | NOVATEC LD | NOVATEC LD | NOVATEC LD | — | NOVATEC LD | NOVATEC LD |
| unevenness- | | | LC720 | LC720 | LC720 | | LC720 | LC720 |
| erasing layer | MFR (g/10 min) | | 9.4 | 9.4 | 9.4 | — | 9.4 | 9.4 |
| | Thickness (μm) | | 2 | 2 | 2 | — | 1 | 2 |
| Roughness- | Material (1) | Trade name | EVAFLEX | EVAFLEX | EVAFLEX | EVAFLEX | EVAFLEX | EVAFLEX |
| expressing | | | EV270 | EV270 | EV270 | EV270 | EV270 | EV270 |
| layer | | MFR (g/10 min) | 1.0 | 1.0 | 1.0 | 1.0 | 1.0 | 1.0 |
| | Material (2) | Trade name | Petrocene | Petrocene | Petrocene | Petrocene | Petrocene | — |
| | | | 209 | 209 | 209 | 209 | 209 | |
| | | MFR (g/10 min) | 45 | 45 | 45 | 45 | 45 | — |

| | Material (1):Material (2) | 30:70 | 30:70 | 30:70 | 30:70 | 30:70 | 100:0 |
|---|---|---|---|---|---|---|---|
| | Thickness (μm) | 2 | 5 | 10 | 2 | 2 | 2 |
| Base | Trade name of material | PF380A | | | | | |
| material | | | | | | | |
| layer | | | | | | | |
| Smooth layer | Trade name of material | NOVATEC LD LC720 | | | | | |
| | Haze value (%) | 13.0 | 14.7 | 21.2 | 31.8 | 23.6 | 6.7 |
| | Arithmetic average surface | 0.51 | 0.66 | 0.88 | 0.89 | 0.53 | 0.61 |
| | roughness Ra (μm) | | | | | | |

| | | | Comparative | Comparative | Comparative | Comparative | Comparative | Comparative |
|---|---|---|---|---|---|---|---|---|
| | | | Example 7 | Example 8 | Example 9 | Example 10 | Example 11 | Example 12 |
| Fine | Trade name of main material | | NOVATEC LD | NOVATEC LD | NOVATEC LD | NOVATEC LD | — | — |
| unevenness- | | | LC720 | LC720 | LC720 | LC720 | | |
| erasing layer | MFR (g/10 min) | | 9.4 | 9.4 | 9.4 | 9.4 | — | — |
| | Thickness (μm) | | 2 | 2 | 2 | 2 | — | — |
| Roughness- | Material (1) | Trade name | EVAFLEX | EVAFLEX | NOVATEC PP | NOVATEC PP | Catalloy | Catalloy |
| expressing | | | EV270 | EV270 | EG8 | EG8 | Q300F | Q300F |
| layer | | MFR (g/10 min) | 1.0 | 1.0 | 0.8 | 0.8 | 0.8 | 0.8 |
| | Material (2) | Trade name | — | — | — | — | WINTEC | — |
| | | | | | | | WFX4 | |
| | | MFR (g/10 min) | — | — | — | — | 7.0 | — |

| | Material (1):Material (2) | 100:0 | 100:0 | 100:0 | 100:0 | 75:25 | 100:0 |
|---|---|---|---|---|---|---|---|
| | Thickness (μm) | 5 | 10 | 2 | 10 | 2 | 2 |
| Base | Trade name of material | PF380A | | | | | |
| material | | | | | | | |
| layer | | | | | | | |
| Smooth layer | Trade name of material | NOVATEC LD LC720 | | | | | |
| | Haze value (%) | 6.6 | 6.8 | 6.8 | 7.2 | 76.7 | 53.5 |
| | Arithmetic average surface | 0.43 | 0.62 | 0.51 | 0.27 | 1.57 | 1.77 |
| | roughness Ra (μm) | | | | | | |

TABLE 2

| | | | Example 7 | Example 8 | Example 9 | Example 10 | Example 11 | Example 12 |
|---|---|---|---|---|---|---|---|---|
| Fine | Trade name of main material | | NOVATEC LD | NOVATEC LD | NOVATEC LD | NOVATEC LD | NOVATEC LD | NOVATEC LD |
| unevenness- | | | LC720 | LC720 | LC720 | LC720 | LC720 | LC720 |
| erasing layer | MFR (g/10 min) | | 9.4 | 9.4 | 9.4 | 9.4 | 9.4 | 9.4 |
| | Thickness (μm) | | 2 | 2 | 2 | 2 | 2 | 2 |
| Roughness- | Material (1) | Trade name | Catalloy | Catalloy | Catalloy | Catalloy | Catalloy | Catalloy |
| expressing | | | Q300F | Q300F | Q300F | Q300F | Q300F | Q300F |
| layer | | MFR (g/10 min) | 0.8 | 0.8 | 0.8 | 0.8 | 0.8 | 0.8 |
| | Material (2) | Trade name | WINTEC | WINTEC | WINTEC | — | — | — |
| | | | WFX4 | WFX4 | WFX4 | | | |
| | | MFR (g/10 min) | 7.0 | 7.0 | 7.0 | — | — | — |

| | Material (1):Material (2) | 75:25 | 75:25 | 75:25 | 100:0 | 100:0 | 100:0 |
|---|---|---|---|---|---|---|---|
| | Thickness (μm) | 2 | 5 | 10 | 2 | 5 | 10 |
| Base | Trade name of material | PF380A | | | | | |
| material | | | | | | | |
| layer | | | | | | | |
| Pressure- | Trade name of material | G1657 (75 parts), ARCON P-125 (25 parts) | | | | | |
| sensitive | | | | | | | |
| adhesive | | | | | | | |
| layer | | | | | | | |
| | Haze value (%) | 17.2 | 18.3 | 22.2 | 10.2 | 12.4 | 16.8 |
| | Arithmetic average surface | 2.50 | 1.40 | 1.22 | 2.13 | 2.47 | 1.34 |
| | roughness Ra (μm) | | | | | | |

| | | | Comparative | Comparative | Comparative | Comparative |
|---|---|---|---|---|---|---|
| | | | Example 13 | Example 14 | Example 15 | Example 16 |
| Fine | Trade name of main material | | NOVATEC LD | NOVATEC LD | — | — |
| unevenness- | | | LC720 | LC720 | | |
| erasing layer | MFR (g/10 min) | | 9.4 | 9.4 | — | — |
| | Thickness (μm) | | 2 | 1 | — | — |
| Roughness- | Material (1) | Trade name | EVAFLEX | EVAFLEX | Catalloy | Catalloy |
| expressing | | | EV270 | EV270 | Q300F | Q300F |
| layer | | MFR (g/10 min) | 1.0 | 1.0 | 0.8 | 0.8 |
| | Material (2) | Trade name | Petrocene | Petrocene | WINTEC | — |
| | | | 209 | 209 | WFX4 | |
| | | MFR (g/10 min) | 45 | 45 | 7.0 | — |

| | | | | |
|---|---|---|---|---|
| Material (1):Material (2) | 30:70 | 30:70 | 75:25 | 100:0 |
| Thickness (μm) | 2 | 2 | 2 | 2 |

| | | |
|---|---|---|
| Base | Trade name of material | PF380A |
| material | | |
| layer | | |
| Pressure- | Trade name of material | G1657 (75 parts), ARCON P-125 (25 parts) |
| sensitive | | |
| adhesive | | |
| layer | | |

| | | | | |
|---|---|---|---|---|
| Haze value (%) | 14.0 | 24.7 | 75.3 | 54.5 |
| Arithmetic average surface | 0.53 | 0.55 | 1.50 | 1.76 |
| roughness Ra (μm) | | | | |

### Example 13

The following compounds were prepared as a roughness-expressing layer-forming material, a fine unevenness-erasing layer-forming material, a base material layer-forming material, a first pressure-sensitive adhesive layer-forming material, and a second pressure-sensitive adhesive layer-forming material.

Roughness-expressing layer-forming material: A mixture of 75 parts of a reactor TPO (Catalloy Q300F manufactured by SunAllomer Ltd.; melt flow rate (MFR)=0.8 (230° C., 2.16 kgf)) and 25 parts of a polypropylene obtained by using a metallocene catalyst (WINTEC WFX4 manufactured by Japan Polypropylene Corporation; melt flow rate (MFR)=7.0 (230° C., 2.16 kgf))

Fine unevenness-erasing layer-forming material: A low-density polyethylene (NOVATEC LD LC720 manufactured by Japan Polyethylene Corporation; melt flow rate (MFR)=9.4 (190° C., 2.16 kgf))

Base material layer-forming material: A block polypropylene (PF380a manufactured by SunAllomer Ltd.)

First pressure-sensitive adhesive layer-forming material: A mixture of 75 parts of a styrene-based elastomer formed of a hydrogenated product of a styrene-butadiene-based copolymer (Tuftec H1041 manufactured by Asahi Kasei Chemicals Corporation) and 25 parts of a tackifier (ARCON P-125 manufactured by Arakawa Chemical Industries, Ltd.)

Second pressure-sensitive adhesive layer-forming material: A mixture of 75 parts of a styrene-based elastomer formed of a hydrogenated product of a styrene-butadiene-based copolymer (G1657 manufactured by Kraton Polymers) and 25 parts of a tackifier (ARCON P-125 manufactured by Arakawa Chemical Industries, Ltd.)

The above-mentioned materials were molded by T-die melt co-extrusion. Thus, a pressure-sensitive adhesive tape (7) including the fine unevenness-erasing layer, the roughness-expressing layer, the base material layer, the first pressure-sensitive adhesive layer, and the second pressure-sensitive adhesive layer in the stated order was obtained. The fine unevenness-erasing layer had a thickness of 2 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (7).

### Example 14

A pressure-sensitive adhesive tape (8) was obtained in the same manner as in Example 13 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (8).

### Example 15

A pressure-sensitive adhesive tape (9) was obtained in the same manner as in Example 13 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (9).

### Example 16

A pressure-sensitive adhesive tape (10) was obtained in the same manner as in Example 13 except that: a mixture of 95 parts of a styrene-based elastomer formed of a hydrogenated product of a styrene-butadiene-based copolymer (Tuftec H1062 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (DYNARON 1320P manufactured by JSR Corporation) and 5 parts of a tackifier (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (10).

### Example 17

A pressure-sensitive adhesive tape (11) was obtained in the same manner as in Example 16 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (11).

### Example 18

A pressure-sensitive adhesive tape (12) was obtained in the same manner as in Example 16 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (12).

### Example 19

A pressure-sensitive adhesive tape (13) was obtained in the same manner as in Example 13 except that: only 100 parts of a reactor TPO (Catalloy Q300F manufactured by SunAllomer Ltd.; melt flow rate (MFR)=0.8 (230° C., 2.16 kgf)) were used as the roughness-expressing layer-forming material; a mixture of 70 parts of a styrene-based elastomer formed of a hydrogenated product of a styrene-butadiene-based copolymer (Tuftec H1041 manufactured by Asahi Kasei Chemicals Corporation) and 30 parts of a tackifies (ARCON P-125 manufactured by Arakawa Chemical Industries, Ltd.) was used as the first pressure-sensitive adhesive layer-forming material; and a mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (13).

### Example 20

A pressure-sensitive adhesive tape (14) was obtained in the same manner as in Example 19 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (14).

### Example 21

A pressure-sensitive adhesive tape (15) was obtained in the same manner as in Example 19 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (15).

### Example 22

A pressure-sensitive adhesive tape (16) was obtained in the same manner as in Example 19 except that a mixture of 70 parts of a styrene-based elastomer formed of a hydrogenated product of a styrene-butadiene-based copolymer (Tuftec H1221 manufactured by Asahi Kasei Chemicals Corporation) and 30 parts of a tackifies (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (16).

### Example 23

A pressure-sensitive adhesive tape (17) was obtained in the same manner as in Example 22 except that the thickness of the roughness-expressing layer was changed to 5 μm. The fine unevenness-erasing layer had a thickness of 2 μm, the roughness-expressing layer had a thickness of 5 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (17).

### Example 24

A pressure-sensitive adhesive tape (18) was obtained in the same manner as in Example 22 except that the thickness of the roughness-expressing layer was changed to 10 μm. The fine unevenness-erasing layer had a thickness of 2 μm, the roughness-expressing layer had a thickness of 10 μm, the base material layer had a thickness of 38 μm, the first pressure-sensitive adhesive layer had a thickness of 4 μm, and the second pressure-sensitive adhesive layer had a thickness of 4 μm. Table 3 shows the results of the evaluation of the resultant pressure-sensitive adhesive tape (18).

### Comparative Example 17

A pressure-sensitive adhesive tape (C5) was obtained in the same manner as in Example 13 except that: a mixture of 30 parts of an ethylene-vinyl acetate copolymer (EVAFLEX EV270 manufactured by DUPONT-MITSUI POLYCHEMICALS CO., LTD.; melt flow rate (MFR)=1.0 (190° C., 2.16 kgf)) and 70 parts of a low-density polyethylene (Petrocene 209 manufactured by TOSOH CORPORATION; melt flow rate (MFR)=45 (190° C., 2.16 kgf)) was used as the roughness-expressing layer-forming material; only 100 parts of a styrene-based elastomer formed of a hydrogenated product of a styrene-butadiene-based copolymer (Tuftec H1041 manufactured by Asahi Kasei Chemicals Corporation) were used as the first pressure-sensitive adhesive layer-forming material; and only 100 parts of a styrene-based elastomer formed of a hydrogenated product of a styrene-butadiene-based copolymer (Tuftec H1062 manufactured by Asahi Kasei Chemicals Corporation) were used as the second pressure-sensitive adhesive layer-forming material. The fine unevenness-erasing layer had a thickness of 2 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C5).

### Comparative Example 18

A pressure-sensitive adhesive tape (C6) was obtained in the same manner as in Comparative Example 17 except that: the thickness of the roughness-expressing layer was changed to 5 μm; a mixture of 70 parts of a styrene-based elastomer formed of a hydrogenated product of a styrene-butadiene-based copolymer (G1657 manufactured by Kraton Polymers) and 30 parts of a tackifier (ARCON P-125 manufactured by Arakawa Chemical Industries, Ltd.) was used as the first pressure-sensitive adhesive layer-forming material; and a mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 5 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C6).

### Comparative Example 19

A pressure-sensitive adhesive tape (C7) was obtained in the same manner as in Comparative Example 17 except that: the thickness of the roughness-expressing layer was changed to 10 μm; a mixture of 75 parts of a styrene-based elastomer formed of a hydrogenated product of a styrene-butadiene-based copolymer (G1657 manufactured by Kraton Polymers) and 25 parts of a tackifier (ARCON P-125 manufactured by Arakawa Chemical Industries, Ltd.) was used as the first pressure-sensitive adhesive layer-forming material; and a mixture of 75 parts of a styrene-based elastomer formed of a hydrogenated product of a styrene-butadiene-based copolymer (DYNARON 1320P manufactured by JSR Corporation) and 25 parts of a tackifier (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 10 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C7).

### Comparative Example 20

A pressure-sensitive adhesive tape (C8) was obtained in the same manner as in Example 13 except that: the fine unevenness-erasing layer was not provided; a mixture of 95 parts of a styrene-based elastomer formed of a hydrogenated product of a styrene-butadiene-based copolymer (Tuftec H1221 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (Tuftec H1062 manufactured by Asahi Kasei Chemicals Corporation) and 5 parts of a tackifier (ARCON P-125 manufactured by Arakawa Chemical Industries, Ltd.) was used as the second pressure-sensitive adhesive layer-forming material. The fine unevenness-erasing layer had a thickness of 0 μm (the layer was absent), the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C8).

### Comparative Example 21

A pressure-sensitive adhesive tape (C9) was obtained in the same manner as in Example 13 except that: the fine unevenness-erasing layer was not provided; only 100 parts of a reactor TPO (Catalloy Q300F manufactured by SunAllomer Ltd.; melt flow rate (MFR)=0.8 (230° C., 2.16 kgf)) were used as the roughness-expressing layer-forming material; a mixture of 70 parts of a styrene-based elastomer formed of a hydrogenated product of a styrene-butadiene-based copolymer (DYNARON 1320P manufactured by JSR Corporation) and 30 parts of a tackifies (ARCON P-125 manufactured by Arakawa Chemical Industries, Ltd.) was used as the first pressure-sensitive adhesive layer-forming material; the thickness of the first pressure-sensitive adhesive layer was changed to 8 μm; and the second pressure-sensitive adhesive layer was not provided. The fine unevenness-erasing layer had a thickness of 0 μm (the layer was absent), the roughness-expressing layer had a thickness of 2 μm, the base material layer had a thickness of 38 μm, the first pressure-sensitive adhesive layer had a thickness of 8 μm, and the second pressure-sensitive adhesive layer had a thickness of 0 μm (the layer was absent). Table 4 shows the results of the evaluation of the resultant pressure-sensitive adhesive tape (C9).

### Comparative Example 22

A pressure-sensitive adhesive tape (C10) was obtained in the same manner as in Example 13 except that: only 100 parts of a random polypropylene (NOVATEC PP EG8 manufactured by Japan Polypropylene Corporation; melt flow rate (MFR)=0.8 (230° C., 2.16 kgf)) were used as the roughness-expressing layer-forming material; the thickness of the roughness-expressing layer was changed to 10 μm; only 100 parts of a styrene-based elastomer formed of a hydrogenated product of a styrene-butadiene-based copolymer (Tuftec H1041 manufactured by Asahi Kasei Chemicals) were used as the first pressure-sensitive adhesive layer-forming material; the thickness of the first pressure-sensitive adhesive layer was changed to 8 μm; and the second pressure-sensitive adhesive layer was not provided. The fine unevenness-erasing layer had a thickness of 2 μm, the roughness-expressing layer had a thickness of 10 μm, the base material layer had a thickness of 38 μm, the first pressure-sensitive adhesive layer had a thickness of 8 μm, and the second pressure-sensitive adhesive layer had a thickness of 0 μm (the layer was absent). Table shows the results of the evaluation of the resultant pressure-sensitive adhesive tape (C10).

### Comparative Example 23

A pressure-sensitive adhesive tape (C11) was obtained in the same manner as in Comparative Example 17 except that the fine unevenness-erasing layer was not provided. The fine unevenness-erasing layer had a thickness of 0 μm (the layer was absent), the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C11).

### Comparative Example 24

A pressure-sensitive adhesive tape (C12) was obtained in the same manner as in Comparative Example 17 except that: the thickness of the fine unevenness-erasing layer was changed to 1 μm; a mixture of 70 parts of a styrene-based elastomer formed of a hydrogenated product of a styrene-butadiene-based copolymer (G1657 manufactured by Kraton Polymers) and 30 parts of a tackifier (ARCON P-125 manufactured by Arakawa Chemical Industries, Ltd.) was used as the first pressure-sensitive adhesive layer-forming material; and a mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.) was used as the second pressure-sensitive adhesive layer-forming material. The fine unevenness-erasing layer had a thickness of 1 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C12).

### Comparative Example 25

A pressure-sensitive adhesive tape (C13) was obtained in the same manner as in Example 13 except that: only 100 parts of an ethylene-vinyl acetate copolymer (EVAFLEX EV270 manufactured by DUPONT-MITSUI POLYCHEMICALS CO., LTD.; melt flow rate (MFR)=1.0 (190° C., 2.16 kgf)) were used as the roughness-expressing layer-forming material; a mixture of 75 parts of a styrene-based elastomer formed of a hydrogenated product of a styrene-butadiene-based copolymer (G1657 manufactured by Kraton Polymers) and 25 parts of a tackifier (ARCON P-125 manufactured by Arakawa Chemical Industries, Ltd.) was used as the first pressure-sensitive adhesive layer-forming material; and a mixture of 75 parts of a styrene-based elastomer formed of a hydrogenated product of a styrene-butadiene-based copolymer (DYNARON 1320P manufactured by JSR Corporation) and 25 parts of a tackifier (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 2 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C13).

### Comparative Example 26

A pressure-sensitive adhesive tape (C14) was obtained in the same manner as in Comparative Example 25 except that: the thickness of the roughness-expressing layer was changed to 5 μm a mixture of 95 parts of a styrene-based elastomer formed of a hydrogenated product of a styrene-butadiene-based copolymer (Tuftec H1221 manufactured by Asahi Kasei Chemicals Corporation) and 5 parts of a tackifier (ARCON P-125 manufactured by Arakawa Chemical Industries, Ltd.) was used as the first pressure-sensitive adhesive layer-forming material; and a mixture of 95 parts of a styrene-based elastomer formed of a hydrogenated product of a styrene-butadiene-based copolymer (Tuftec H1062 manufactured by Asahi Kasei Chemicals Corporation) and 5 parts of a tackifier (ARCON P-125 manufactured by Arakawa Chemical Industries, Ltd.) was used as the second pressure-sensitive adhesive layer-forming material. The fine unevenness-erasing layer had a thickness of 2 μm, the roughness-expressing layer had a thickness of 5 μm, the base material layer had a thickness of 38 μm, the first pressure-sensitive adhesive layer had a thickness of 4 μm, and the second pressure-sensitive adhesive layer had a thickness of 4 μm. Table 4 shows the results of the evaluation of the resultant pressure-sensitive adhesive tape (C14).

### Comparative Example 27

A pressure-sensitive adhesive tape (C15) was obtained in the same manner as in Comparative Example 25 except that: the thickness of the roughness-expressing layer was changed to 10 μm; a mixture of 70 parts of a styrene-based elastomer formed of a hydrogenated product of a styrene-butadiene-based copolymer (DYNARON 1320P manufactured by JSR Corporation) and 30 parts of a tackifier (ARCON P-125 manufactured by Arakawa Chemical Industries, Ltd.) was used as the first pressure-sensitive adhesive layer-forming material; the thickness of the first pressure-sensitive adhesive layer was changed to 8 μm; and the second pressure-sensitive adhesive layer was not provided. The fine unevenness-erasing layer had a thickness of 2 μm, the roughness-expressing layer had a thickness of 10 μm, the base material layer had a thickness of 38 μm, the first pressure-sensitive adhesive layer had a thickness of 8 μm, and the second pressure-sensitive adhesive layer had a thickness of 0 μm (the layer was absent). Table 4 shows the results of the evaluation of the resultant pressure-sensitive adhesive tape (C15).

### Comparative Example 28

A pressure-sensitive adhesive tape (C16) was obtained in the same manner as in Comparative Example 22 except that the thickness of the roughness-expressing layer was changed to 2 μm. The fine unevenness-erasing layer had a thickness of 2 μm, the roughness-expressing layer had a thickness of 2 μm, the base material layer had a thickness of 38 μm, the first pressure-sensitive adhesive layer had a thickness of 8 μm, and the second pressure-sensitive adhesive layer had a thickness of 0 μm (the layer was absent). Table shows the results of the evaluation of the resultant pressure-sensitive adhesive tape (C16).

TABLE 3

| | | | Example | Example | Example | Example | Example | Example |
|---|---|---|---|---|---|---|---|---|
| | | | 13 | 14 | 15 | 16 | 17 | 18 |
| Fine | Trade name of main | | NOVATEC | NOVATEC | NOVATEC | NOVATEC | NOVATEC | NOVATEC |
| unevenness- | material | | LD LC720 | LD LC720 | LD LC720 | LD LC720 | LD LC720 | LD LC720 |
| erasing | MFR (g/ 10 min) | | 9.4 | 9.4 | 9.4 | 9.4 | 9.4 | 9.4 |
| layer | Thickness (μm) | | 2 | 2 | 2 | 2 | 2 | 2 |
| Roughness- | Material (1) | Trade name | Catalloy | Catalloy | Catalloy | Catalloy | Catalloy | Catalloy |
| expressing | | | Q300F | Q300F | Q300F | Q300F | Q300F | Q300F |
| layer | | MFR (g/10 | 0.8 | 0.8 | 0.8 | 0.8 | 0.8 | 0.8 |
| | | min) | | | | | | |
| | Material (2) | Trade name | WINTEC | WINTEC | WINTEC | WINTEC | WINTEC | WINTEC |
| | | | WFX4 | WFX4 | WFX4 | WFX4 | WFX4 | WFX4 |
| | | MFR (g/10 | 7.0 | 7.0 | 7.0 | 7.0 | 7.0 | 7.0 |
| | | min) | | | | | | |
| | Material (1):Material (2) | | 75:25 | 75:25 | 75:25 | 75:25 | 75:25 | 75:25 |
| | Thickness (μm) | | 2 | 5 | 10 | 2 | 5 | 10 |
| Base | Trade name of material | | PF308A | | | | | |
| material | Thickness (μm) | | 38 | | | | | |
| layer | | | | | | | | |
| First | Trade name | Rubber-based | Tuftec | Tuftec | Tuftec | Tuftec | Tuftec | Tuftec |
| pressure- | | resin | H1041 | H1041 | H1041 | H1062 | H1062 | H1062 |
| sensitive | | component | | | | | | |
| adhesive | | Tackifier | ARCON | ARCON | ARCON | ARCON | ARCON | ARCON |
| layer | | | P125 | P125 | P125 | P125 | P125 | P125 |
| | Rubber-based resin | | 75:25 | 75:25 | 75:25 | 95:5 | 95:5 | 95:5 |
| | component:Tackifier | | | | | | | |
| | Thickness (μm) | | 4 | 4 | 4 | 4 | 4 | 4 |
| | Storage modulus (Pa) | | 1.3 × 10⁶ | 1.3 × 10⁶ | 1.3 × 10⁶ | 4.5 × 10⁶ | 4.5 × 10⁶ | 4.5 × 10⁶ |
| Second | Trade name | Rubber-based | G1657 | G1657 | G1657 | DYNARON | DYNARON | DYNARON |
| pressure- | | resin | | | | 1320P | 1320P | 1320P |
| sensitive | | component | | | | | | |
| adhesive | | Tackifier | ARCON | ARCON | ARCON | ARCON | ARCON | ARCON |
| layer | | | P125 | P125 | P125 | P125 | P125 | P125 |
| | Rubber-based resin | | 75:25 | 75:25 | 75:25 | 95:5 | 95:5 | 95:5 |
| | component:Tackifier | | | | | | | |
| | Thickness (μm) | | 4 | 4 | 4 | 4 | 4 | 4 |
| | Storage modulus (Pa) | | 5.2 × 10⁵ | 5.2 × 10⁵ | 5.2 × 10⁵ | 5.9 × 10⁵ | 5.9 × 10⁵ | 5.9 × 10⁵ |
| Adhesion (N/20 mm) | | | 0.03 | 0.03 | 0.03 | 0.045 | 0.045 | 0.045 |
| Prism sheet lens apex angle | | | 4.28 | 4.28 | 4.28 | 3.37 | 3.37 | 3.37 |
| portion indentation depth (μm) | | | | | | | | |
| Deformation of prism sheet lens | | | ∘ | ∘ | ∘ | ∘ | ∘ | ∘ |
| apex angle | | | | | | | | |
| Indentation | | | ∘ | ∘ | ∘ | ∘ | ∘ | ∘ |
| Haze value (%) | | | 18.2 | 19.1 | 22.4 | 18.8 | 18.5 | 22.8 |
| Arithmetic average surface | | | 2.50 | 1.41 | 1.23 | 2.51 | 1.43 | 1.23 |
| roughness Ra (μm) | | | | | | | | |
| | | | Example | Example | Example | Example | Example | Example |
| | | | 19 | 20 | 21 | 22 | 23 | 24 |
| Fine | Trade name of main | | NOVATEC | NOVATEC | NOVATEC | NOVATEC | NOVATEC | NOVATEC |
| unevenness- | material | | LD LC720 | LD LC720 | LD LC720 | LD LC720 | LD LC720 | LD LC720 |
| erasing | MFR (g/ 10 min) | | 9.4 | 9.4 | 9.4 | 9.4 | 9.4 | 9.4 |
| layer | Thickness (μm) | | 2 | 2 | 2 | 2 | 2 | 2 |
| Roughness- | Material (1) | Trade name | Catalloy | Catalloy | Catalloy | Catalloy | Catalloy | Catalloy |
| expressing | | | Q300F | Q300F | Q300F | Q300F | Q300F | Q300F |
| layer | | MFR (g/10 | 0.8 | 0.8 | 0.8 | 0.8 | 0.8 | 0.8 |
| | | min) | | | | | | |
| | Material (2) | Trade name | — | — | — | — | — | — |
| | | MFR (g/10 | — | — | — | — | — | — |
| | | min) | | | | | | |
| | Material (1):Material (2) | | 100:0 | 100:0 | 100:0 | 100:0 | 100:0 | 100:0 |
| | Thickness (μm) | | 2 | 5 | 10 | 2 | 5 | 10 |
| Base | Trade name of material | | PF308A | | | | | |
| material | Thickness (μm) | | 38 | | | | | |
| layer | | | | | | | | |
| First | Trade name | Rubber-based | Tuftec | Tuftec | Tuftec | Tuftec | Tuftec | Tuftec |
| pressure- | | resin | H1041 | H1041 | H1041 | H1041 | H1041 | H1041 |
| sensitive | | component | | | | | | |
| adhesive | | Tackifier | ARCON | ARCON | ARCON | ARCON | ARCON | ARCON |
| layer | | | P125 | P125 | P125 | P125 | P125 | P125 |
| | Rubber-based resin | | 70:30 | 70:30 | 70:30 | 70:30 | 70:30 | 70:30 |
| | component:Tackifier | | | | | | | |
| | Thickness (μm) | | 4 | 4 | 4 | 4 | 4 | 4 |
| | Storage modulus (Pa) | | 1.3 × 10⁶ | 1.3 × 10⁶ | 1.3 × 10⁶ | 1.3 × 10⁶ | 1.3 × 10⁶ | 1.3 × 10⁶ |
| Second | Trade name | Rubber-based | DYNARON | DYNARON | DYNARON | Tuftec | Tuftec | Tuftec |
| pressure- | | resin | 1320P | 1320P | 1320P | H1221 | H1221 | H1221 |
| sensitive | | component | | | | | | |
| adhesive | | Tackifier | ARCON | ARCON | ARCON | ARCON | ARCON | ARCON |
| layer | | | P125 | P125 | P125 | P125 | P125 | P125 |

| | | | | | | |
|---|---|---|---|---|---|---|
| Rubber-based resin | 70:30 | 70:30 | 70:30 | 70:30 | 70:30 | 70:30 |
| component:Tackifier | | | | | | |
| Thickness (μm) | 4 | 4 | 4 | 4 | 4 | 4 |
| Storage modulus (Pa) | 4.1 × 10⁵ | 4.1 × 10⁵ | 4.1 × 10⁵ | 7.0 × 10⁵ | 7.0 × 10⁵ | 7.0 × 10⁵ |

| | | | | | | |
|---|---|---|---|---|---|---|
| Adhesion (N/20 mm) | 0.04 | 0.04 | 0.04 | 0.03 | 0.03 | 0.03 |
| Prism sheet lens apex angle | 5.89 | 5.89 | 5.89 | 3.7 | 3.7 | 3.7 |
| portion indentation depth (μm) | | | | | | |
| Deformation of prism sheet lens | ∘ | ∘ | ∘ | ∘ | ∘ | ∘ |
| apex angle | | | | | | |
| Indentation | ∘ | ∘ | ∘ | ∘ | ∘ | ∘ |
| Haze value (%) | 12.3 | 13.4 | 17.9 | 11.7 | 14.3 | 17.9 |
| Arithmetic average surface | 2.22 | 2.54 | 1.44 | 2.16 | 2.60 | 1.41 |
| roughness Ra (μm) | | | | | | |

TABLE 4

| | | | Comparative | Comparative | Comparative | Comparative | Comparative | Comparative |
|---|---|---|---|---|---|---|---|---|
| | | | Example 17 | Example 18 | Example 19 | Example 20 | Example 21 | Example 22 |
| Fine | Trade name of main | | NOVATEC | NOVATEC | NOVATEC | — | — | NOVATEC |
| unevenness- | material | | LD LC720 | LD LC720 | LD LC720 | | | LD LC720 |
| erasing | MFR (g/10 min) | | 9.4 | 9.4 | 9.4 | — | — | 9.4 |
| layer | Thickness (μm) | | 2 | 2 | 2 | — | — | 2 |
| Roughness- | Material (1) | Trade name | EVAFLEX | EVAFLEX | EVAFLEX | Catalloy | Catalloy | NOVATEC |
| expressing | | | EV270 | EV270 | EV270 | Q300F | Q300F | PPEG8 |
| layer | | MFR (g/10 | 1.0 | 1.0 | 1.0 | 0.8 | 0.8 | 0.8 |
| | | min) | | | | | | |
| | Material (2) | Trade name | Petrocene | Petrocene | Petrocene | WINTEC | — | — |
| | | | 209 | 209 | 209 | WFX4 | | |
| | | MFR (g/10 | 45 | 45 | 45 | 7.0 | — | — |
| | | min) | | | | | | |
| | Material (1):Material (2) | | 30:70 | 30:70 | 30:70 | 75:25 | 100:0 | 100:0 |
| | Thickness (μm) | | 2 | 5 | 10 | 2 | 2 | 10 |
| Base | Trade name of material | | PF308A | | | | | |
| material | Thickness (μm) | | 38 | | | | | |
| layer | | | | | | | | |
| First | Trade name | Rubber-based | Tuftec | G1657 | G1657 | Tuftec | DYNARON | Tuftec |
| pressure- | | resin | H1041 | | | H1221 | 1320P | H1041 |
| sensitive | | component | | | | | | |
| adhesive | | Tackifier | — | ARCON | ARCON | ARCON | ARCON | — |
| layer | | | | P125 | P125 | P125 | P125 | |
| | Rubber-based resin | | 100:0 | 70:30 | 75:25 | 95:5 | 70:30 | 100:0 |
| | component:Tackifier | | | | | | | |
| | Thickness (μm) | | 4 | 4 | 4 | 4 | 8 | 8 |
| | Storage modulus (Pa) | | 3.2 × 10⁶ | 6.7 × 10⁵ | 5.2 × 10⁵ | 5.9 × 10⁵ | 4.1 × 10⁵ | 3.2 × 10⁶ |
| Second | Trade name | Rubber-based | Tuftec | DYNARON | DYNARON | Tuftec | — | — |
| pressure- | | resin | H1062 | 1320P | 1320P | H1062 | | |
| sensitive | | component | | | | | | |
| adhesive | | Tackifier | — | ARCON | ARCON | — | — | — |
| layer | | | | P125 | P125 | | | |
| | Rubber-based resin | | 100:0 | 70:30 | 75:25 | 95:5 | — | — |
| | component:Tackifier | | | | | | | |
| | Thickness (μm) | | 4 | 4 | 4 | 4 | — | — |
| | Storage modulus (Pa) | | 1.3 × 10⁶ | 4.1 × 10⁵ | 4.2 × 10⁵ | 4.5 × 10⁶ | — | — |
| Adhesion (N/20 mm) | | | Not | 0.086 | 0.07 | Not | 0.08 | Not |
| | | | bonded | | | bonded | | bonded |
| Prism sheet lens apex angle | | | 0 | 11.12 | 8.28 | 0.05 | 11.2 | 0 |
| portion indentation depth (μm) | | | | | | | | |
| Deformation of prism sheet lens | | | ∘ | x | x | ∘ | x | ∘ |
| apex angle | | | | | | | | |
| Indentation | | | ∘ | x | x | ∘ | x | ∘ |
| Haze value (%) | | | 14.1 | 13.7 | 20.3 | 75.3 | 54.5 | 7.1 |
| Arithmetic average surface | | | 0.51 | 0.65 | 0.86 | 1.5 | 1.76 | 0.27 |
| roughness Ra (μm) | | | | | | | | |
| | | | Comparative | Comparative | Comparative | Comparative | Comparative | Comparative |
| | | | Example 23 | Example 24 | Example 25 | Example 26 | Example 27 | Example 28 |
| Fine | Trade name of main | | — | NOVATEC | NOVATEC | NOVATEC | NOVATEC | NOVATEC |
| unevenness- | material | | | LD LC720 | LD LC720 | LD LC720 | LD LC720 | LD LC720 |
| erasing | MFR (g/10 min) | | — | 9.4 | 9.4 | 9.4 | 9.4 | 9.4 |
| layer | Thickness (μm) | | — | 1 | 2 | 2 | 2 | 2 |
| Roughness- | Material (1) | Trade name | EVAFLEX | EVAFLEX | EVAFLEX | EVAFLEX | EVAFLEX | NOVATEC |
| expressing | | | EV270 | EV270 | EV270 | EV270 | EV270 | PP EG8 |
| layer | | MFR (g/10 | 1.0 | 1.0 | 1.0 | 1.0 | 1.0 | 0.8 |
| | | min) | | | | | | |
| | Material (2) | Trade name | Petrocene | Petrocene | — | — | — | — |
| | | | 209 | 209 | | | | |
| | | MFR (g/10 | 45 | 45 | — | — | — | — |
| | | min) | | | | | | |
| | Material (1):Material (2) | | 30:70 | 30:70 | 100:0 | 100:0 | 100:0 | 100:0 |
| | Thickness (μm) | | 2 | 2 | 2 | 5 | 10 | 2 |
| Base | Trade name of material | | PF308A | | | | | |
| material | Thickness (μm) | | 38 | | | | | |
| layer | | | | | | | | |
| First | Trade name | Rubber-based | Tuftec | G1657 | G1657 | Tuftec | DYNARON | Tuftec |
| pressure- | | resin | H1041 | | | H1221 | 1320P | H1041 |
| sensitive | | component | | | | | | |
| adhesive | | Tackifier | — | ARCON | ARCON | ARCON | ARCON | — |
| layer | | | | P125 | P125 | P125 | P125 | |
| | Rubber-based resin | | 100:0 | 70:30 | 75:25 | 95:5 | 70:30 | 100:0 |
| | component:Tackifier | | | | | | | |
| | Thickness (μm) | | 4 | 4 | 4 | 4 | 8 | 8 |
| | Storage modulus (Pa) | | 3.2 × 10⁶ | 6.7 × 10⁵ | 5.2 × 10⁵ | 5.9 × 10⁵ | 4.1 × 10⁵ | 3.2 × 10⁶ |
| Second | Trade name | Rubber-based | Tuftec | DYNARON | DYNARON | Tuftec | — | — |
| pressure- | | resin | H1062 | 1320P | 1320P | H1062 | | |
| sensitive | | component | | | | | | |
| adhesive | | Tackifier | — | ARCON | ARCON | ARCON | — | — |
| layer | | | | P125 | P125 | P125 | | |

| | | | | | | |
|---|---|---|---|---|---|---|
| Rubber-based resin | 100:0 | 70:30 | 75:25 | 95:5 | — | — |
| component:Tackifier | | | | | | |
| Thickness (μm) | 4 | 4 | 4 | 4 | — | — |
| Storage modulus (Pa) | 1.3 × 10⁶ | 4.1 × 10⁵ | 4.2 × 10⁵ | 4.5 × 10⁶ | — | — |

| | | | | | | |
|---|---|---|---|---|---|---|
| Adhesion (N/20 mm) | Not | 0.086 | 0.07 | Not | 0.08 | Not |
| | bonded | | | bonded | | bonded |
| Prism sheet lens apex angle | 0 | 11.12 | 8.28 | 0.05 | 11.2 | 0 |
| portion indentation depth (μm) | | | | | | |
| Deformation of prism sheet lens | ∘ | x | x | ∘ | x | ∘ |
| apex angle | | | | | | |
| Indentation | ∘ | x | x | ∘ | x | ∘ |
| Haze value (%) | 32.6 | 24.3 | 7.5 | 6.9 | 7.9 | 7.4 |
| Arithmetic average surface | 0.87 | 0.57 | 0.62 | 0.45 | 0.65 | 0.54 |
| roughness Ra (μm) | | | | | | |

As is apparent from Tables 1 and 2, the laminated films and the pressure-sensitive adhesive tapes obtained in the examples each have targeted haze and targeted surface roughness. In addition, the laminated films and the pressure-sensitive adhesive tapes obtained in the comparative examples could not obtain targeted haze or targeted surface roughness, and hence were general laminated films and pressure-sensitive adhesive tapes each having low haze and low surface roughness. In addition, it has been elucidated that the laminated films and the pressure-sensitive adhesive tapes obtained in Comparative Examples 11, 12, 15, and 16 each of which is free of any fine unevenness-erasing layer each involve the emergence of such a drawback that an external appearance inspection is hardly performed because, although high surface roughness can be obtained, haze increases and hence transparency reduces.

As shown in Table 3, the pressure-sensitive adhesive tape of the present invention is found to be such a pressure-sensitive adhesive tape as described below capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged, and further, the pressure-sensitive adhesive tape is adjusted so as to be capable of achieving compatibility between low haze property excellent in transparency and such large surface roughness that foreign matter such as a fish eye is hardly observed without fluctuations in mechanical properties of the entire pressure-sensitive adhesive tape. In addition, the pressure-sensitive adhesive tape of the present invention is found to be such a pressure-sensitive adhesive tape as described below. When a prism sheet having multiple triangle pole-shaped prisms fixed on its surface is used as the above-mentioned member having unevenness on its surface, the pressure-sensitive adhesive tape functions as a surface protective film capable of effectively protecting a lens surface, and brings together sufficient pressure-sensitive adhesiveness for, and sufficient releasability from, the prism sheet. In addition, when the prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be suppressed.

On the other hand, as shown in Table 4, in the case of a pressure-sensitive adhesive tape that does not meet a requirement of the pressure-sensitive adhesive tape of the present invention, the following fact is found. That is, the pressure-sensitive adhesive tape cannot bring together sufficient pressure-sensitive adhesiveness for, and sufficient releasability from, a member having unevenness on its surface. Alternatively, upon deformation of the member protected with the pressure-sensitive adhesive tape by, for example, lamination or continuous winding, the uneven shape deforms, a base material layer in the pressure-sensitive adhesive tape is damaged, the mechanical properties of the entire pressure-sensitive adhesive tape fluctuate, or compatibility between low haze property excellent in transparency and such large surface roughness that foreign matter such as a fish eye is hardly observed cannot be achieved. In addition, in the case of the pressure-sensitive adhesive tape that does not meet a requirement of the pressure-sensitive adhesive tape of the present invention, the following fact is found. That is, when a prism sheet having multiple triangle pole-shaped prisms fixed on its surface is used as the above-mentioned member having unevenness on its surface, the pressure-sensitive adhesive tape cannot effectively protect a lens surface or cannot bring together sufficient pressure-sensitive adhesiveness for, and sufficient releasability from, the prism sheet. Alternatively, when the prism sheet protected with the pressure-sensitive adhesive tape is brought into a state such as a laminated state or a continuously wound state, irregularity (indentation) emerges in the external appearance of the prism sheet to which the pressure-sensitive adhesive tape is attached.

### INDUSTRIAL APPLICABILITY

The laminated film and pressure-sensitive adhesive tape of the present invention can be widely used in applications for the production of electronic parts, for structures, for automobiles, and the like where design is requested such as a protecting application, an external appearance-adjusting application, a decorating application, and a labeling application. In particular, the laminated film and pressure-sensitive adhesive tape of the present invention each enable the performance of an efficient external appearance inspection because the laminated film and the pressure-sensitive adhesive tape each have the ease of an external appearance inspection based on its low haze and such surface roughness that no erroneous recognition of foreign matter occurs. Further, the laminated film and pressure-sensitive adhesive tape of the present invention are each applicable to, for example, a film for adjusting the external appearance of a film for design as well. The usage of the laminated film and the pressure-sensitive adhesive tape covers abroad spectrum including: members excellent in design requested in the fields of automobiles and housing construction materials; films for decoration, labeling, and the like; and films for protecting, and adjusting the design of, optical members.

In addition, the pressure-sensitive adhesive tape of the present invention is such a pressure-sensitive adhesive tape as described below capable of protecting the uneven surface of a member having unevenness on its surface. The pressure-sensitive adhesive tape brings together sufficient pressure-sensitive adhesiveness for, and sufficient releasability from, the member. In addition, even upon deformation of the member protected with the pressure-sensitive adhesive tape by, for example, lamination or continuous winding, the uneven shape does not deform and a base material layer in the pressure-sensitive adhesive tape is not damaged, and further, the pressure-sensitive adhesive tape is adjusted so as to be capable of achieving compatibility between low haze property excellent in transparency and such large surface roughness that foreign matter such as a fish eye is hardly observed without fluctuations in mechanical properties of the entire pressure-sensitive adhesive tape. In addition, the pressure-sensitive adhesive tape of the present invention is such a pressure-sensitive adhesive tape as described below. When a prism sheet having multiple triangle pole-shaped prisms fixed on its surface is used as the above-mentioned member having unevenness on its surface, the pressure-sensitive adhesive tape functions as a surface protective film capable of effectively protecting a lens surface, and brings together sufficient pressure-sensitive adhesiveness for, and sufficient releasability from, the prism sheet. In addition, when the prism sheet protected with the pressure-sensitive adhesive tape is brought into a state such as a laminated state or a continuously wound state, the emergence of irregularity (indentation) in the external appearance of the prism sheet to which the pressure-sensitive adhesive tape is attached can be suppressed. Accordingly, the pressure-sensitive adhesive tape is suitable for, for example, the protection of uneven members each provided with design by forming unevenness on its surface, the uneven members being used in the fields of automobiles and housing construction materials, and the protection of optical members each having unevenness on its surface such as a prism sheet.

### REFERENCE SINGS LIST

1 base material layer
2 roughness-expressing layer
3 fine unevenness-erasing layer
10 laminated film
20 pressure-sensitive adhesive layer
21 first pressure-sensitive adhesive layer
22 second pressure-sensitive adhesive layer
100 pressure-sensitive adhesive tape

1. A laminated film, comprising:
a base material layer;
a roughness-expressing layer; and
a fine unevenness-erasing layer in the stated order,
wherein:
the base material layer contains a thermoplastic resin;
the roughness-expressing layer contains at least one kind of a resin component (A) selected from polyethylenes, ethylene-vinyl acetate copolymers, propylene-based polymers, and olefin-based thermoplastic elastomers;
the fine unevenness-erasing layer contains a thermoplastic resin (B);
an arithmetic average surface roughness Ra on a surface on a side of the fine unevenness-erasing layer is 1.0 μm to 3.0 μm; and
the laminated film has a haze value of 30% or less.

2. The laminated film according to claim 1, wherein the roughness-expressing layer has a thickness of 2 μm to 10 μm.

3. The laminated film according to claim 1, wherein the fine unevenness-erasing layer has a thickness of 1 μm to 10 μm.

4. The laminated film according to claim 1, wherein the roughness-expressing layer has two or more melting temperatures Tm in differential scanning calorimetry.

5. The laminated film according to claim 1, wherein the roughness-expressing layer contains at least one kind selected from the propylene-based polymers and the olefin-based thermoplastic elastomers.

6. A pressure-sensitive adhesive tape comprising a pressure-sensitive adhesive layer on one side of the laminated film according to claim 1.

7. The pressure-sensitive adhesive tape according to claim 6, wherein a haze value is 30% or less.

8. The pressure-sensitive adhesive tape according to claim 6, wherein the fine unevenness-erasing layer contains a long-chain alkyl-based releasing agent.

9. The pressure-sensitive adhesive tape according to claim 6, wherein:
the pressure-sensitive adhesive layer has a first pressure-sensitive adhesive layer and a second pressure-sensitive adhesive layer in the stated order from the side of the laminated film; and
a storage modulus of the first pressure-sensitive adhesive layer is higher than a storage modulus of the second pressure-sensitive adhesive layer.

10. The pressure-sensitive adhesive tape according to claim 9, wherein the first pressure-sensitive adhesive layer has a storage modulus of 1.0×10⁶ Pa or more and less than 1.0×10⁹ Pa at a frequency of 10 Hz and 23° C.

11. The pressure-sensitive adhesive tape according to claim 9, wherein the second pressure-sensitive adhesive layer has a storage modulus of 1.0×10³ Pa or more and less than 1.0×10⁶ Pa at a frequency of 10 Hz and 23° C.

12. The pressure-sensitive adhesive tape according to claim 9, wherein:
a pressure-sensitive adhesive of which the first pressure-sensitive adhesive layer is constituted comprises a thermoplastic pressure-sensitive adhesive; and
a pressure-sensitive adhesive of which the second pressure-sensitive adhesive layer is constituted comprises a thermoplastic pressure-sensitive adhesive.

13. The pressure-sensitive adhesive tape according to claim 9, wherein the pressure-sensitive adhesive tape comprises a surface protective film for a prism sheet.
